(19) United States
(12) Patent Application Publication
(10) Pub. No.: US 2025/0388776 A1
(43) Pub. Date: Dec. 25, 2025

(54) Aqueous Coating Compositions Having Excellent Storage Stability and Coatings Thereof Having Excellent Water Barrier Properties

(71) Applicant: Covestro (Netherlands) B.V., Geleen (NL)

(72) Inventors: Jurgen Scheerder, Buren (NL); Jens De Bont, Dongen (NL); Mourad Aabich, Tilburg (NL)

(21) Appl. No.: 19/159,419

(22) PCT Filed: Dec. 15, 2023
(86) PCT No.: PCT/EP2023/086147

§ 371 Date: Aug. 25, 2025

(30) Foreign Application Priority Data
Dec. 19, 2022 (EP) 22214641.7

(51) Int. Cl. C09D 151/00; C08K 5/09; C09D 7/63; C09D 7/65; D21H 19/12; D21H 19/18; D21H 19/20; D21H 27/28

(52) U.S. Cl. CPC C09D 151/003; C08K 5/09; C09D 7/63; C09D 7/65; D21H 19/12; D21H 19/18; D21H 19/20; D21H 27/28

(57) ABSTRACT

The invention relates to an aqueous coating composition. The invention further relates to a coating obtained by drying the aqueous coating composition of the invention. The invention further relates to a substrate (preferably the substrate is paper or paperboard) that is at least partly coated with at least a coating of the invention.

### CROSS-REFERENCE TO RELATED APPLICATIONS

This application is the United States National Phase of International Patent Application No. PCT/EP2023/086147 filed Dec. 15, 2023, and claims priority to European Patent Application No. 22214641.7 filed Dec. 19, 2022, the disclosures of which are hereby incorporated by reference in their entireties.

### BACKGROUND

### Technical Field

The invention lies in the field of aqueous coating compositions comprising at least an acid-rich vinyl copolymer, an acid-poor vinyl copolymer, a wax and a fatty acid containing a carboxylic acid group at one end and a hydrocarbon group with at least 19 and at most 40 carbon atoms at the other end.

### Description of Related Art

There is an increasing demand for aqueous coating compositions with enhanced storage stability providing for coatings suitable for paper food-packaging with good water barrier properties. Unfortunately, the aqueous coating compositions known in the art do not provide for the combination of enhanced storage stability with respect to said composition and good water barrier properties.

Enhanced storage stability of aqueous coating compositions combined with enhanced water barrier properties of coatings derived upon curing of aqueous coating compositions that are suitable for paper food-packaging are desirable for a variety of reasons. Food-packaging material must ensure the freshness of packaged food. Plastics used as food-packaging material excel in water barrier properties and as such plastic food-packaging material is currently the material of choice in food-packaging because it ensures the freshness of packaged food. However, given the gradually increasing ban of plastics in view of the negative impact of plastics on the environment, there is an emerging trend in the food-packaging industry to substitute plastics by paper as the material in food-packaging. Unfortunately, this is not a straightforward substitution since it is well-known that paper suffers from very poor water barrier properties and as such the freshness of packaged food is severely compromised; good water barrier properties are necessary for maintaining the freshness of packaged food. At the same time, the deposition and formation of any coating on paper requires the use of aqueous coating compositions since paper is typically treated via aqueous-based processes. These processes comprise a number of water baths through which paper substrates treated already with an aqueous coating composition at an earlier stage of the process have to subsequently go through these various water baths during which the deposited aqueous coating composition should be stable which means not showing signs of sedimentation, creaming, phase separation, or gelation. If an aqueous coating composition is not stable during the paper's coating process, this will result in uneven coating thickness which subsequently have a detrimental effect on the water barrier properties of the coated paper thus compromising the freshness of the packaged food. Thus, consistency of the coating thickness is essential; therefore, one of the reasons that enhanced storage stability is desirable for aqueous coating compositions intended to provide for coatings suitable for paper food-packaging is also related to the freshness of the packaged food. An additional reason for enhanced storage stability of aqueous coating compositions intended to provide for coatings suitable for paper food-packaging, is that allows storage for longer time periods, a feature that it is highly desirable by the formulators of coating compositions suitable for treating paper intended for food-packaging.

The WO 2009/097166 A1 provided for coating compositions comprising: a) a first liquid, b) a first polymer dispersed in the first liquid, said first polymer having a mean particle size less than or equal to 5000 nanometers; and c) a second polymer dispersed in the first liquid, said second polymer having a mean particle size of less than 50 nanometers, said second polymer comprises at least 5 wt % of the total combined weight of the first and second polymer. When the coating compositions of WO 2009/097166 A1 were used to coat substrates, the coated substrates exhibited improved anti-blocking characteristics and when said coated substrates were used to form hermetic seals and packages, the hermetic seals exhibited improved low temperature sealing properties; when the hermetic seals comprise a package for a product, the hermetic seals exhibited improved hot tack properties. According to the WO 2009/097166 A1 these properties were due to the optimization of the particle sizes of the first and the second polymer. The WO 2009/097166 A1 disclosed that the first copolymer comprises ethylene and an alpha-olefin having less than 20 carbon atoms. The WO 2009/097166 A1 did not—at least—disclose aqueous coating compositions comprising at least an acid-rich vinyl copolymer, an acid-poor vinyl copolymer, a wax and a fatty acid, as each one of them is specified in the specification. In addition, the WO 2009/097166 A1 did not deal with the provision of aqueous coating compositions having excellent storage stability and coatings thereof having excellent water barrier properties.

The U.S. Pat. No. 4,097,433 provided for a heat-sealable composition comprising a copolymer of vinylidene chloride, at least one other ethylenically unsaturated monomer copolymerizable therewith, and at least 5 wt % of methacrylonitrile, the copolymer containing at least 88 wt % vinylidene chloride and, per 100 parts by weight of the total copolymer, 2.7 to 3.3 parts by weight of behenic acid, 0.4 to 0.6 parts by weight of carnauba wax, 1.2 to 1.8 parts by weight of candelilla wax, 0.5 to 1.0 part by weight of stearamide, and 2.7 to 3.3 parts by weight of glycerol monostearate. The heat-sealable compositions of the U.S. Pat. No. 4,097,433 provided for coated films which were suitable for use in the automatic packaging industry and also for lamination to other films and as a substrate for extrusion coating. The U.S. Pat. No. 4,097,433 did not—at least—disclose aqueous coating compositions comprising at least an acid-rich vinyl copolymer, an acid-poor vinyl copolymer, a wax and a fatty acid, as each one of them is specified in the specification. In addition, the U.S. Pat. No. 4,097,433 did not deal with the provision of aqueous coating compositions having excellent storage stability and coatings thereof having excellent water barrier properties.

The U.S. Pat. No. 3,179,532 provided for a process for improving the properties of regenerated cellulose film wherein the regenerated cellulose film is cast, purified, softened, dried and coated with a coalescible film-forming material from an aqueous dispersion of said material and the coating is then smoothed and dried, the improvement which comprises applying to said film after purification but prior to the first drying step an aqueous solution containing a water-soluble salt of a polymer obtained from 20 to 30 percent by weight of at least one dialkylamino ethyl acrylate and 70 to 80 percent by weight of at least one acrylic ester, said polymer having an inherent viscosity of 0.1-1.0, said salt being formed with a fatty acid having up to 6 carbon atoms; removing excess solution; and thereafter, heating said film under controlled conditions of temperature and time to dry the film and insolubilize the polymer; and then applying to said film a coalescible film-forming material from an aqueous dispersion thereof. The U.S. Pat. No. 3,179,532 did not—at least—disclose aqueous coating compositions comprising at least an acid-rich vinyl copolymer, an acid-poor vinyl copolymer, a wax and a fatty acid, as each one of them is specified in the specification. In addition, the U.S. Pat. No. 3,179,532 did not deal with the provision of aqueous coating compositions having excellent storage stability and coatings thereof having excellent water barrier properties.

The U.S. Pat. No. 5,763,100 provided for a recyclable paper stock comprising: a substrate coated on at least one surface with a water based emulsion coating; said coating consisting essentially of: 20-90 dry wt. % of an acrylic-styrene copolymer which consists essentially of acrylic monomers and styrene, having a glass transition temperature below 50° C.; 5-70 dry wt. % of a wax component selected from the group consisting of paraffin wax, microcrystalline wax, polyethylene wax and a blend of two or more of said waxes; and an acrylic copolymer having glass transition temperature above 30° C., present in an amount up to 60 dry wt. % in order to provide good blocking characteristics; wherein said coating forms a water resistant film on said substrate surface. The U.S. Pat. No. 5,763,100 did not—at least—disclose aqueous coating compositions comprising at least an acid-rich vinyl copolymer, an acid-poor vinyl copolymer, a wax and a fatty acid, as each one of them is specified in the specification. In addition, the U.S. Pat. No. 5,763,100 did not deal with the provision of aqueous coating compositions having excellent storage stability and coatings thereof having excellent water barrier properties.

None of WO 2009/097166 A1, U.S. Pat. Nos. 4,097,433, 3,179,532 and 5,763,100, disclosed an aqueous coating composition as disclosed in the specification and none of them dealt with the provision of aqueous coating compositions having excellent storage stability and coatings thereof having excellent water barrier properties, let alone provide a solution to this problem.

Therefore, the use of paper as an environmentally friendly option to substitute environment polluting materials such as plastics, in the food-packaging industry will be limited, unless a technical solution that would provide for aqueous coating compositions having excellent storage stability and coatings thereof having excellent water barrier properties.

Such a desired technical solution still represents an unmet need since the solution to such a problem, is particularly challenging and complex.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY

The invention relates to an aqueous coating composition. The invention further relates to a coating obtained by drying the aqueous coating composition of the invention. The invention further relates to a substrate (preferably the substrate is paper or paperboard) that is at least partly coated with at least a coating of the invention.

The goal of the invention is to provide for aqueous coating compositions having excellent storage stability and coatings thereof having excellent water barrier properties.

This goal was surprisingly achieved by the aqueous coating compositions, as described in the claims and disclosed in the specification.

More particularly, it has surprisingly been found that aqueous coating compositions of the invention had excellent storage stability and afforded coatings with excellent water barrier properties.

The aqueous coating compositions of the invention constitute a major technological advancement for at the food-packaging industry, since they enable the replacement of plastics—used currently as packaging material in food-packaging—by paper without compromising the freshness of the packaged food, given the excellent storage stability of the aqueous coating compositions of the invention and the excellent water barrier properties of the coatings derived from the aqueous coating compositions of the invention; both the storage stability and the water barrier properties were greatly enhanced over the compositions of the state-of-the-art.

The invention is as set out in the claims. Many other variations, combinations, substitutions and embodiments within the scope of the claims are disclosed in the specification. However, it will be recognized by persons having ordinary skill in the art that additional not expressly disclosed variations, combinations, substitutions and embodiments may be made within the scope of the claims, and are encompassed in the scope of the claims. Thus, it is contemplated and understood that this specification supports additional variations, combinations, substitutions and embodiments within the scope of the claims; such additional variations, combinations, substitutions and embodiments within the scope of the claims may be obtained, for example, by combining, modifying, or reorganizing any of the disclosed components, elements, features, characteristics, limitations, of the various expressly disclosed variations, combinations, substitutions and embodiments and claims, as disclosed in the specification and within the scope of the claims.

### DETAILED DESCRIPTION

The specification provides definitions for certain technical terms used in the specification and/or the claims. Any other technical term used in the specification and/or the claims that is not defined in the specification has the meaning attributed to it by one of ordinary skill in the art.

By ‘vinyl polymer’ is meant in the specification a polymer derived from the addition polymerisation preferably from the free-radical polymerisation, of at least one ethylenically unsaturated monomer.

By ‘vinyl monomer’ is meant in the specification an ethylenically unsaturated monomer.

By ‘excellent storage stability’ of an aqueous coating composition is meant in the specification that the aqueous coating composition shows no sedimentation, no creaming, no phase separation and no gelation during or at the end of the storage period, as the storage stability was assessed in the specification.

By ‘poor storage stability’ of an aqueous coating composition is meant in the specification that the aqueous coating composition shows any one or any combination of sedimentation, creaming, phase separation, and gelation during or at the end of the storage period, as the storage stability was assessed in the specification.

By ‘excellent water barrier properties’ is meant in the specification that the coating obtained upon drying an aqueous coating composition (equally referred to as the ‘dry coating’) has:
a Cobb₁₈₀₀, determined as described in the specification, lower than 6, preferably lower than 5, more preferably lower than 4, even more preferably lower than 3 g/m²,
and
a Moisture Vapor Transmission Rate (abbreviated as ‘MVTR’) determined as described in the specification, lower than 50 g·m⁻²·24 h⁻¹.

By ‘average particle size’ is meant in the specification the intensity-based average particle size (known as Z-average) determined via photon correlation spectroscopy as described in the specification.

By ‘room temperature’ is meant herein 23±0.5° C.

By ‘atmospheric pressure’ is meant in the specification pressure of 1 atm (1 atm=101325 Pa).

By ‘standard conditions’ is meant in the specification room temperature and atmospheric pressure, collectively.

By ‘lower than’ is meant in the specification that the relevant maximum boundary value is not included in the range.

By ‘higher than’ is meant in the specification that the relevant minimum boundary value is not included in the range.

By ‘rpm’ is meant revolutions per minute.

The weight average molecular weight, determined as described in the specification, is abbreviated as M_{w}.

The decimal separator in numbers (also known as the radix character) is indicated with a period (‘.’).

By ‘pph’ is meant in the specification weight parts per one hundred weight parts.

By ‘n.a.’ is meant in the specification not applicable.

By ‘n.m.’ is meant in the specification not measured.

By ‘n.d.’ is meant in the specification not determined.

Every constituent and every component of the compositions of the invention is different and distinct from any other component and constituent of the composition of the invention.

The total sum of any quantities expressed as percentages, in the specification including the claims, cannot (allowing for rounding errors) exceed 100 wt. % of the composition. For example, the sum of all components of which the composition of the invention (or part(s) thereof) comprises may, when expressed as a weight (or other) percentage of the composition (or the same part(s) thereof), total 100 wt. % allowing for rounding errors. However, where a list of components is non-exhaustive the sum of the percentage for each of such components may be less than 100 wt. % to allow a certain percentage for additional amount(s) of any additional component(s) that may not be explicitly described herein.

All combinations of minimum and maximum values of the parameters disclosed in the specification may be used to define the parameter ranges for various preferments or embodiments of the invention.

For all upper and lower boundaries of any parameters given herein, the boundary value is included in each range for each parameter. All combinations of minimum and maximum values of the parameters described herein may be used to define the parameter ranges for various embodiments and preferences of the invention.

Unless otherwise explicitly stated, any feature, element, component, embodiment, range and especially any preferred feature, preferred element, preferred embodiment, preferred range, preferred combination of ranges, preferments, and embodiments of the invention as these are disclosed in the entire specification including the claims can be combined with each other.

Unless the context indicates otherwise, the plural forms of the terms in the specification are construed as including the singular form and vice versa.

Certain moieties, species, groups, repeat units, compounds, oligomers, polymers, materials, mixtures, compositions and/or formulations which comprise and/or are used in some or all of the invention as described in the specification may exist as one or more different forms such as any of those in the following non-exhaustive list: stereoisomers (such as enantiomers (e.g. E and/or Z forms), diastereoisomers and/or geometric isomers); tautomers (e.g. keto and/or enol forms). The invention comprises and/or uses all such forms which are effective as defined in the specification.

This section (Detailed Disclosure of the Invention) together with the claims provides for the disclosure of the invention as well as for explicit preferments and embodiments of the claimed invention; thus, the disclosure presented in this section, along with these explicit preferments and embodiments disclosed in this section are within the scope of the claimed invention.

The invention provides for an aqueous coating composition as described in claim 1. The subject matter of this paragraph is mentioned in the specification as ‘A0’.

More particularly, the invention provides for an aqueous coating composition comprising components (A), (B) and (C):
(A) from 80 to 98, preferably at least 82 and at most 98, more preferably at least 82 and at most 97.5, even more preferably at least 82 and at most 97, for example at least 82 and at most 96, for example at least 85 and at most 98, for example at least 85 and at most 97.5, for example at least 85 and at most 97, for example at least 85 and at most 96 wt. % relative to the total amount of components (A) and (B), of at least two vinyl polymers, namely
   an acid-rich vinyl copolymer (A1) and
   an acid-poor vinyl copolymer (A2),
wherein
the acid-rich vinyl copolymer (A1) comprises carboxylic acid functional ethylenically unsaturated monomers in an amount of from 5 to 35 wt. %, and ethylenically unsaturated monomers different from carboxylic acid functional ethylenically unsaturated monomers, selected from the group consisting of acrylic esters, methacrylic esters, arylalkylenes and itaconates (preferably the itaconates are selected from the group consisting of esters of itaconic acid and mixtures thereof, more preferably the itaconates are selected from the group of diesters of itaconic acid, and mixtures thereof), in an amount of from 65 to 95 wt. % relative to the total amount of ethylenically unsaturated monomers used to prepare the acid-rich vinyl copolymer (A1),
and wherein
the acid-poor vinyl copolymer (A2) comprises carboxylic acid functional ethylenically unsaturated monomers in an amount of from 0 to 3 wt. %, and ethylenically unsaturated monomers different from carboxylic acid functional ethylenically unsaturated monomers, selected from the group consisting of acrylic esters, methacrylic esters, arylalkylenes and itaconates (preferably the itaconates are selected from the group consisting of esters of itaconic acid and mixtures thereof, more preferably the itaconates are selected from the group of diesters of itaconic acid, and mixtures thereof), in an amount of from 97 to 100 wt. % relative to the total weight of monomers charged in the polymerization to prepare the acid-poor vinyl copolymer (A2),
and wherein
the weight ratio of (A1) to (A2) is preferably from 10:90 to 40:60, more preferably from 20:80 to 35:65,
(B) from 2 to 20 wt. % relative to the total amount of components (A) and (B), of at least one wax,
(C) at least one fatty acid containing a carboxylic acid group at one end and a hydrocarbon group with at least 19 and at most 40 carbon atoms at the other end, and wherein
the weight ratio of the amount of fatty acids containing a carboxylic acid group at one end and a hydrocarbon group with at least 19 and at most 40 carbon atoms at the other end that make up component (C) to the amount of waxes that make up component (B) is from 0.10 to 1.20, preferably from 0.12 to 1.20,
and wherein
the total amount of components (A), (B) and (C) in the composition is from 30 to 70, preferably from 35 to 60 wt. % on composition.
   The subject matter of this paragraph is mentioned in the specification as ‘A1’.

The component (B) may comprise a fatty acid that reads on component (C). For example, beeswax contains a fatty acid that reads on component (C). In case the component (B) comprises a fatty acid that reads on component (C), then the amount of fatty acid that reads on component (C) and is present in the component (B), is (must be) included in determining the amount of the component (C) and is not (must not be) included in determining the amount of component (B).

The weight ratio of (A1) to (A2) is preferably from 10:90 to 40:60, more preferably from 20:80 to 35:65. An equally alternative expression is that the weight ratio of (A1): (A2) is preferably from 10:90 to 40:60, more preferably from 20:80 to 35:65. A yet another equally alternative expression is that the weight ratio of (A1) to (A2) defined as the weight amount of (A1) divided by the weight amount of (A2) is at least 0.11 and at most 0.66, preferably at least 0.25 and at most 0.54. All these equally alternative expressions as to the weight ratio of (A1) to (A2), mean that the amount of the acid-rich vinyl copolymer (A1) must be at least 10 and at most 40 wt. % relative to the aggregate amount of the acid-rich vinyl copolymer (A1) and the acid-poor vinyl copolymer (A2), while the amount of the acid-poor vinyl copolymer (A2) must be at least 60 and at most 90 wt. % relative to the aggregate amount of the acid-rich vinyl copolymer (A1) and the acid-poor vinyl copolymer (A2).

The acid-rich vinyl copolymer (A1) is preferably obtained by conventional free-radically initiated polymerization in bulk or solution known to those skilled in the art. The bulk polymerization is preferably a semi-continuous or a continuous process using, for example, a plug flow reactor, or a hot tube reactor. Bulk polymerization of vinyl monomers is described in detail in GB 1107249 A, U.S. Pat. Nos. 4,529,787 A and 4,414,370 A. The acid-rich vinyl copolymer (A1) is prepared via bulk polymerization, and it is preferably made water-dispersible by partial or full deprotonation of its carboxylic acid groups. with a deprotonation agent A. Preferably the deprotonation agent A is selected from the group consisting of bases and mixtures thereof; more preferably the deprotonation agent A is selected from the group consisting of organic bases, inorganic bases and mixtures thereof; for example the deprotonation agent A is selected from the group consisting of organic amines, inorganic bases and mixtures thereof; for example the deprotonation agent A is selected from the group consisting of organic amines, ammonia, sodium hydroxide, potassium hydroxide, lithium hydroxide and mixtures thereof; for example the deprotonation agent A is selected from the group consisting of alkyl amines, alkanol amines, morpholine, ammonia, sodium hydroxide, potassium hydroxide, lithium hydroxide, and mixtures thereof; for example the deprotonation agent A is selected from the group consisting of triethyl amine, tributyl amine, ethanol amine, N-methyl ethanol amine, N,N-dimethyl ethanol amine, morpholine, ammonia, sodium hydroxide, potassium hydroxide, lithium hydroxide, and mixtures thereof; for example the deprotonation agent A is selected from the group consisting of triethyl amine, tributyl amine, ethanol amine, N-methyl ethanol amine, N,N-dimethyl ethanol amine, ammonia, sodium hydroxide, potassium hydroxide, lithium hydroxide, and mixtures thereof; for example the deprotonation agent A is selected from the group consisting of N,N-dimethyl ethanol amine, ammonia, sodium hydroxide, potassium hydroxide, lithium hydroxide, and mixtures thereof; for example the deprotonation agent A is selected from the group consisting of N,N-dimethyl ethanol amine, ammonia, sodium hydroxide, potassium hydroxide, and mixtures thereof; for example the deprotonation agent A is selected from the group consisting of N,N-dimethyl ethanol amine, ammonia, and mixtures thereof; for example the deprotonation agent A is selected from the group consisting of ammonia, organic amines, sodium hydroxide, potassium hydroxide and mixtures thereof; for example the deprotonation agent A is selected from the group consisting of ammonia, organic amines, and mixtures thereof; for example the deprotonation agent A is ammonia. If the acid-rich vinyl copolymer (A1) is prepared using solution polymerization, the acid-rich vinyl copolymer (A1) is dissolved in a suitable solvent. Suitable solvents have preferably a boiling point at atmospheric pressure of lower than 150, more preferably lower then 130, even more preferably lower than 100, most preferably lower than 90° C. Preferred examples of solvents include but are not limited to acetone, methylethyl ketone, ethanol, i-propanol, ethyl acetate, butyl acetate and toluene, more preferably acetone and methylethyl ketone; other suitable solvents will be well known to those skilled in the art. In case in which the polymerization temperature exceeds that of the boiling point of solvent and/or monomer, the polymerization is performed under pressure. The acid-rich vinyl copolymer (A1) prepared via solution polymerization can be dissolved or dispersed in water using a deprotonation agent A and once the acid-rich vinyl copolymer (A1) is partly or fully deprotonated it can be used as is. It is, however, preferred if a solvent is used in the polymerization step, to remove the solvent after the acid-rich vinyl copolymer (A1) is dispersed in water using a deprotonation agent. One can remove the solvent by increasing the temperature or reducing the pressure, preferably combining both. However, the solvent may also be removed after the acid-rich vinyl copolymer (A1) is used in the subsequent steps that are described below. To prepare the acid-rich vinyl copolymer (A1) a free-radical initiator is used. Suitable free-radical-yielding initiators include inorganic peroxides such as percarbonates; organic peroxides, such as acyl peroxides including e.g. benzoyl peroxide, alkyl hydroperoxides such as t-butyl hydroperoxide and cumene hydroperoxide; dialkyl peroxides such as di-t-butyl peroxide; peroxy esters such as t-butyl perbenzoate and the like; mixtures may also be used. Azo functional initiators may also be used. Preferred azo initiators include 2,2′-azodi(2-methylbutyronitrile) and 4,4′-azobis(4-cyanovaleric acid). The amount of initiator or initiator system used is conventional, e.g. within the range 0.05 to 6 wt percent based on the total vinyl monomers used to prepare the acid-rich vinyl copolymer (A1). Preferred initiators include 2,2′-azodi(2-methylbutyronitrile), 4,4′-azobis(4-cyanovaleric acid), peroxy esters and mixtures thereof. The molecular weight of the acid-rich vinyl copolymer (A1) can be regulated by initiator concentration and temperature.

The acid-poor vinyl copolymer (A2) is preferably obtained by solution, emulsion or suspension polymerization, known to those skilled in the art, more preferably by emulsion polymerization. More preferably, the acid-poor vinyl copolymer (A2) is prepared by free-radically initiated aqueous emulsion polymerization in the presence of the acid-rich vinyl copolymer (A1). Thus, once the acid-rich vinyl copolymer (A1) is prepared as described in the specification, preferably the acid-rich vinyl copolymer (A1) is at least partially deprotonated by a deprotonation agent A selected from the group consisting of bases and mixtures thereof (for further preferments as to the deprotonation agent A, see the relevant text in the specification), the preparation of the acid-poor vinyl copolymer (A2) is carried out via emulsion polymerization; the emulsion polymerization applied for the preparation of the acid-poor vinyl copolymer (A2) is a free-radically initiated emulsion polymerization that is conducted using appropriate heating and agitation e.g. stirring. The free-radically initiated emulsion polymerization is usually effected at atmospheric pressure and a temperature in the range from 30 to 100° C., preferably from 50 to 100° C., more preferably from 60 to 100° C., even more preferably from 60 to 90° C. Suitable free-radical-yielding initiators include persulphates such as ammonium, potassium and sodium salts of persulphate, or redox initiator systems such as combinations of t-butyl hydroperoxide and/or hydrogen peroxide and/or cumene hydroperoxide, with one or both of isoascorbic acid and sodium formaldehyde sulphoxylate, and optionally ethylenediaminetetraacetic acid iron (III) sodium salt hydrate (FeEDTA). Typically, the amount of initiator, or initiator system, ranges from 0.05 to 3 wt. % based on the weight of total monomers charged to prepare the acid-poor vinyl copolymer (A2).

Preferably the aqueous coating composition is as disclosed in A0 or A1 or as in any combination derived from the disclosure in this section and the entire specification including the claims, wherein the weight average molecular weight of the component (A) determined via Size Exclusion Chromatography (abbreviated as SEC) as described in the specification, is from 5000 to 5000000, preferably from 5000 to 1000000, more preferably from 5000 to 800000, most preferably from 5000 to 600000, especially from 5000 to 500000 g/mol. The subject matter of this paragraph is mentioned in the specification as ‘A2’.

Preferably the aqueous coating composition is as disclosed in any one of A0 to A2 or as in any combination derived from the disclosure in this section and the entire specification including the claims, wherein aqueous coating composition as claim in any of the preceding claims, wherein the acid rich vinyl copolymer (A1) is at least partially deprotonated with a deprotonation agent A selected from the group consisting of bases and mixtures thereof; more preferably the deprotonation agent A is selected from the group consisting of organic bases, inorganic bases and mixtures thereof; for example the deprotonation agent A is selected from the group consisting of organic amines, inorganic bases and mixtures thereof; for example the deprotonation agent A is selected from the group consisting of organic amines, ammonia, sodium hydroxide, potassium hydroxide, lithium hydroxide and mixtures thereof; for example the deprotonation agent A is selected from the group consisting of alkyl amines, alkanol amines, morpholine, ammonia, sodium hydroxide, potassium hydroxide, lithium hydroxide, and mixtures thereof; for example the deprotonation agent A is selected from the group consisting of triethyl amine, tributyl amine, ethanol amine, N-methyl ethanol amine, N,N-dimethyl ethanol amine, morpholine, ammonia, sodium hydroxide, potassium hydroxide, lithium hydroxide, and mixtures thereof; for example the deprotonation agent A is selected from the group consisting of triethyl amine, tributyl amine, ethanol amine, N-methyl ethanol amine, N,N-dimethyl ethanol amine, ammonia, sodium hydroxide, potassium hydroxide, lithium hydroxide, and mixtures thereof; for example the deprotonation agent A is selected from the group consisting of N,N-dimethyl ethanol amine, ammonia, sodium hydroxide, potassium hydroxide, lithium hydroxide, and mixtures thereof; for example the deprotonation agent A is selected from the group consisting of N,N-dimethyl ethanol amine, ammonia, sodium hydroxide, potassium hydroxide, and mixtures thereof; for example the deprotonation agent A is selected from the group consisting of N,N-dimethyl ethanol amine, ammonia, and mixtures thereof; for example the deprotonation agent A is selected from the group consisting of ammonia, organic amines, sodium hydroxide, potassium hydroxide and mixtures thereof; for example the deprotonation agent A is selected from the group consisting of ammonia, organic amines, and mixtures thereof; for example the deprotonation agent A is ammonia. The subject matter of this paragraph is mentioned in the specification as ‘A3’.

Preferably the aqueous coating composition is as disclosed in any one of A0 to A3 or as in any combination derived from the disclosure in this section and the entire specification including the claims, wherein the aqueous coating composition as claim in any one of the preceding claims, wherein the component (B) is present in an amount of at most 15 wt. % relative to the total amount of components (A) and (B). The subject matter of this paragraph is mentioned in the specification as ‘A4’.

Preferably the aqueous coating composition is as disclosed in any one of A0 to A4 or as in any combination derived from the disclosure in this section and the entire specification including the claims, wherein aqueous coating composition as claim in any one of the preceding claims, wherein the component (B) is present in an amount of at least 2.5 wt. % relative to the total amount of components (A) and (B). The subject matter of this paragraph is mentioned in the specification as ‘A5’.

Preferably the aqueous coating composition is as disclosed in any one of A0 to A5 or as in any combination derived from the disclosure in this section and the entire specification including the claims, wherein the at least one fatty acid contains a carboxylic acid group at one end and a hydrocarbon group with at least 20, preferably at least 21, more preferably at least 22, and at most 40, preferably at most 38, more preferably at most 37 carbon atoms at the other end. The subject matter of this paragraph is mentioned in the specification as ‘A6’.

Examples of fatty acids containing a carboxylic acid group at one end and a hydrocarbon group with at least 19 and at most 40 carbon atoms at the other end that make up component (C) include but are not limited to behenic acid, lignoceric acid, cerotic acid, erucic acid and docosahexaenoic acid. The at least one fatty acid containing a carboxylic acid group at one end and a hydrocarbon group with at least 19 and at most 40 carbon atoms at the other end may be present in a mixture with other fatty acids, for example Radiacid® 0075, Radiacid® 0565, Radiacid® 0560, available from Oleon®.

Preferably the aqueous coating composition is as disclosed in any one of A0 to A6 or as in any combination derived from the disclosure in this section and the entire specification including the claims, wherein the at least one fatty acid containing a carboxylic acid group at one end and a hydrocarbon group with at least 19 and at most 40 carbon atoms at the other end is deprotonated with a deprotonation agent B which is selected from the group consisting of bases and mixtures thereof; more preferably the deprotonation agent B is selected from the group consisting of organic bases, inorganic bases and mixtures thereof; for example the deprotonation agent B is selected from the group consisting of organic amines, inorganic bases and mixtures thereof; for example the deprotonation agent B is selected from the group consisting of organic amines, ammonia, sodium hydroxide, potassium hydroxide, lithium hydroxide and mixtures thereof; for example the deprotonation agent B is selected from the group consisting of alkyl amines, alkanol amines, morpholine, ammonia, sodium hydroxide, potassium hydroxide, lithium hydroxide, and mixtures thereof; for example the deprotonation agent B is selected from the group consisting of triethyl amine, tributyl amine, ethanol amine, N-methyl ethanol amine, N,N-dimethyl ethanol amine, morpholine, ammonia, sodium hydroxide, potassium hydroxide, lithium hydroxide, and mixtures thereof; for example the deprotonation agent B is selected from the group consisting of triethyl amine, tributyl amine, ethanol amine, N-methyl ethanol amine, N,N-dimethyl ethanol amine, ammonia, sodium hydroxide, potassium hydroxide, lithium hydroxide, and mixtures thereof; for example the deprotonation agent B is selected from the group consisting of N,N-dimethyl ethanol amine, ammonia, sodium hydroxide, potassium hydroxide, lithium hydroxide, and mixtures thereof; for example the deprotonation agent B is selected from the group consisting of N,N-dimethyl ethanol amine, ammonia, sodium hydroxide, potassium hydroxide, and mixtures thereof; for example the deprotonation agent B is selected from the group consisting of N,N-dimethyl ethanol amine, ammonia, and mixtures thereof; for example the deprotonation agent B is selected from the group consisting of ammonia, organic amines, sodium hydroxide, potassium hydroxide and mixtures thereof; for example the deprotonation agent B is selected from the group consisting of ammonia, organic amines, and mixtures thereof; for example the deprotonation agent B is ammonia. The subject matter of this paragraph is mentioned in the specification as ‘A7’.

Preferably the aqueous coating composition is as disclosed in any one of A0 to A7 or as in any combination derived from the disclosure in this section and the entire specification including the claims, wherein aqueous coating composition as claim in any one of the preceding claims, where the at least one was is selected from the group consisting of the subject matter of this paragraph is mentioned in the specification as ‘A8’.

Waxes are grouped as either natural or synthetic, with this classification being possible because of their origin. The natural ones are further categorized into animal, vegetable and mineral waxes (vegetable waxes are also known as plant waxes). Examples of synthetic waxes include but are not limited to paraffin wax, microcrystalline wax, polyolefin wax (e.g. polyethylene wax, polypropylene wax), polytetrafluoroethylene wax, Vestowax® waxes (offered by Evonik), Fischer-Tropsch waxes, polyamide wax and polyvinyl wax. Examples of animal waxes include but are not limited to beeswax, Chinese wax, lanolin, shellac wax (from the lac insect Kerria lacca), spermaceti (from the head cavities and blubber of the sperm whale). Examples of vegetable waxes include but are not limited to bayberry wax, candelilla wax, carnauba wax, esparto wax, ouricury wax, rice bran wax, soy wax, tallow tree wax, jojoba oil. Examples of mineral waxes include but are not limited to ceresin, montan wax, ozocerite, and peat wax. The type of wax in an aqueous coating composition can be identified via one or a combination of analytical techniques such as Nuclear Magnetic Resonance (NMR), Fourier Transform Infrared spectroscopy (FT-IR) and Differential Scanning calorimetry (DSC).

Preferably the aqueous coating composition is as disclosed in any one of A0 to A8 or as in any combination derived from the disclosure in this section and the entire specification including the claims, wherein the carboxylic acid functional ethylenically unsaturated monomer(s) are preferably selected from the group consisting of itaconic acid, itaconic anhydride, mono-alkylesters of itaconic acid, mono-aryl esters of itaconic acid, acrylic acid, methacrylic acid, β-carboxyethyl acrylate and any mixture thereof; more preferably the carboxylic acid functional ethylenically unsaturated monomer is selected from the group consisting of acrylic acid, methacrylic acid, β-carboxyethyl acrylate and mixtures thereof; most preferably the carboxylic acid functional ethylenically unsaturated monomer is selected from the group consisting of methacrylic acid, acrylic acid and mixtures thereof; for example the carboxylic acid functional ethylenically unsaturated monomer is acrylic acid. The subject matter of this paragraph is mentioned in the specification as ‘A9’.

Preferably the aqueous coating composition is as disclosed in any one of A0 to A9 or as in any combination derived from the disclosure in this section and the entire specification including the claims, wherein the ethylenically unsaturated monomers different from carboxylic acid functional ethylenically unsaturated monomers [present in the acid-rich vinyl copolymer (A1) and the acid-poor vinyl copolymer (A2)], are selected from the group consisting of ethylenically unsaturated amides, vinyl esters, vinyl ethers, ethylenically unsaturated nitriles, heterocyclic vinyl compounds, diesters of fumaric acid, diesters of maleic acid, arylalkylenes, esters of itaconic acid, esters of acrylic acid of formula (1)

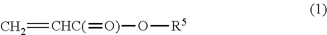

wherein R⁵ is either an optionally substituted alkyl of 1 to 20 carbon atoms, preferably of 1 to 8 carbon atoms, or a cycloalkyl of 5 to 12 ring carbon atoms,
esters of methacrylic acid of formula (2)

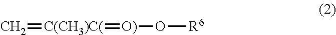

wherein R⁶ is either an optionally substituted alkyl of 1 to 20 carbon atoms, preferably of 1 to 8 carbon atoms, or a cycloalkyl of 5 to 12 ring carbon atoms,
polyalkylene oxide functionalized esters of acrylic acid of formula (3)

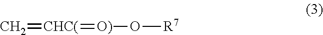

wherein R⁷ is either (CH₂CH₂—O)ₙ—R⁸ or [C(CH₃)CH₂—O]ₙ—R⁸, wherein n is an integer ranging from and including 1 up to an including 50, and wherein R⁸ is either H or an alkyl of 1 to 20 carbon atoms,
and polyalkylene oxide functionalized esters of methacrylic acid of formula (4)

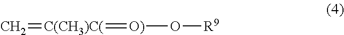

wherein R⁹ is either (CH₂CH₂—O)ₙ—R¹⁰ or [C(CH₃)CH₂—O]ₙ—R¹⁰ wherein n is an integer ranging from and including 1 up to an including 50, and wherein R¹⁰ is either H or an alkyl of 1 to 20 carbon atoms. The subject matter of this paragraph is mentioned in the specification as ‘A10’.

Examples of ethylenically unsaturated amides include but are not limited to diacetone acrylamide. Examples of vinyl esters include but are not limited to allyl acetate, allyl chloroacetate, methallyl acetate, vinyl acetate, isopropenyl acetate. Examples of vinyl ethers include but are not limited to ethyl vinyl ether. Examples of ethylenically unsaturated nitriles include but are not limited to acrylonitrile and methacrylonitrile. Examples of heterocyclic vinyl compounds include but are not limited to 1-vinylimidazole. Examples of diesters of fumaric acid include but are not limited to dimethyl fumarate, diethyl fumarate. Examples of diesters of maleic acid include but are not limited to dimethyl maleate, diethyl maleate. Examples of adducts of fumaric acid include but are not limited to dihydroxy alkyl (preferably an alkyl with 1 to 6 carbon atoms) adducts of fumaric acid. Examples of adducts of maleic acid include but are not limited to dihydroxy alkyl (preferably an alkyl with 1 to 6 carbon atoms) adducts of maleic acid. Examples of adducts of phthalic acid include but are not limited to dihydroxy alkyl (preferably an alkyl with 1 to 6 carbon atoms) adducts of phthalic acid. Examples of arylalkylenes included but are not limited to styrene, a-methyl styrene, o-methyl styrene, m-methyl styrene, p-methyl styrene, pentachlorostyrene, o-chlorostyrene, m-chlorostyrene, p-chlorostyrene and p-cyanostyrene. Examples of esters of acrylic acid of formula (1) include but are not limited to methyl acrylate, ethyl acrylate, n-propyl acrylate, n-butyl acrylate, i-butyl acrylate, t-butyl acrylate, 2-octyl acrylate, 2-ethylhexyl acrylate, lauryl acrylate, isopropyl acrylate, cyclohexyl acrylate, 2-hydroxyethyl acrylate, 2-hydroxy-n-propyl acrylate 3-hydroxy-n-propyl acrylate, 4-hydroxy-n-butyl acrylate hydroxystearyl acrylate. Examples of esters of methacrylic acid of formula (2) include but are not limited to methyl methacrylate, ethyl methacrylate, n-propyl methacrylate, isopropyl methacrylate, n-butyl methacrylate, i-butyl methacrylate, t-butyl methacrylate, cyclohexyl methacrylate, 2-ethylhexyl methacrylate, 2-octyl methacrylate, lauryl methacrylate, 2-hydroxyethyl methacrylate, 2-hydroxy-n-propyl methacrylate, 3-hydroxy-n-propyl methacrylate, 4-hydroxy-n-butyl methacrylate, hydroxystearyl methacrylate. Examples of polyalkylene oxide functionalized esters of acrylic acid of formula (3) include but are not limited to Bisomer® PEA6 (R⁷ is (CH₂CH₂—O)ₙ—H and n=6) supplied by GEO Specialty Chemicals UK. Examples of polyalkylene oxide functionalized esters of methacrylic acid of formula (4) include but are not limited to Bisomer® MPEG350MA (R⁹ is (CH₂CH₂—O)ₙ—CH₃ and n=8) GEO Specialty Chemicals UK.

Preferably the aqueous coating composition is as disclosed in any one of A0 to A9 or as in any combination derived from the disclosure in this section and the entire specification including the claims, wherein the ethylenically unsaturated monomers different from carboxylic acid functional ethylenically unsaturated monomers [present in the acid-rich vinyl copolymer (A1) and the acid-poor vinyl copolymer (A2)], are selected from the group consisting of ethylenically unsaturated amides, vinyl esters, ethylenically unsaturated nitriles, heterocyclic vinyl compounds, diesters of fumaric acid, diesters of maleic acid, arylalkylenes, esters of itaconic acid, esters of acrylic acid of formula (1)

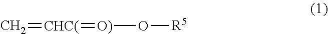

wherein R⁵ is either an optionally substituted alkyl of 1 to 20 carbon atoms, preferably of 1 to 8 carbon atoms, or a cycloalkyl of 5 to 12 ring carbon atoms, esters of methacrylic acid of formula (2)

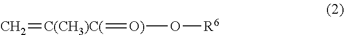

wherein R⁶ is either an optionally substituted alkyl of 1 to 20 carbon atoms, preferably of 1 to 8 carbon atoms, or a cycloalkyl of 5 to 12 ring carbon atoms,
polyalkylene oxide functionalized esters of acrylic acid of formula (3)

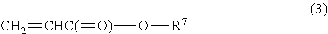

wherein R⁷ is either (CH₂CH₂—O)ₙ—R⁸ or [C(CH₃)CH₂—O]ₙ—R⁸, wherein n is an integer ranging from and including 1 up to an including 50, and wherein R⁸ is either H or an alkyl of 1 to 20 carbon atoms,
and polyalkylene oxide functionalized esters of methacrylic acid of formula (4)

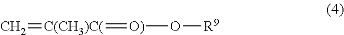

wherein R⁹ is either (CH₂CH₂—O)ₙ—R¹⁰ or [C(CH₃)CH₂—O]ₙ—R¹⁰ wherein n is an integer ranging from and including 1 up to an including 50, and wherein R¹⁰ is either H or an alkyl of 1 to 20 carbon atoms. The subject matter of this paragraph is mentioned in the specification as ‘A11’.

Preferably the aqueous coating composition is as disclosed in any one of A0 to A9 or as in any combination derived from the disclosure in this section and the entire specification including the claims, wherein the ethylenically unsaturated monomers different from carboxylic acid functional ethylenically unsaturated monomers [present in the acid-rich vinyl copolymer (A1) and the acid-poor vinyl copolymer (A2)], are selected from the group consisting of ethylenically unsaturated amides, vinyl esters, vinyl ethers, ethylenically unsaturated nitriles, heterocyclic vinyl compounds, diesters of fumaric acid, diesters of maleic acid, esters of acrylic acid of formula (1)

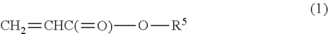

wherein R⁵ is either an optionally substituted alkyl of 1 to 20 carbon atoms, preferably of 1 to 8 carbon atoms, or a cycloalkyl of 5 to 12 ring carbon atoms, esters of methacrylic acid of formula (2)

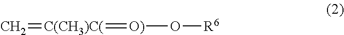

wherein R⁶ is either an optionally substituted alkyl of 1 to 20 carbon atoms, preferably of 1 to 8 carbon atoms, or a cycloalkyl of 5 to 12 ring carbon atoms,
polyalkylene oxide functionalized esters of acrylic acid of formula (3)

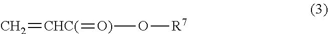

wherein R⁷ is either (CH₂CH₂—O)ₙ—R⁸ or [C(CH₃)CH₂—O]ₙ—R⁸, wherein n is an integer ranging from and including 1 up to an including 50, and wherein R⁸ is either H or an alkyl of 1 to 20 carbon atoms,
and polyalkylene oxide functionalized esters of methacrylic acid of formula (4)

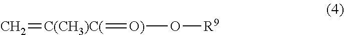

wherein R⁹ is either (CH₂CH₂—O)ₙ—R¹⁰ or [C(CH₃)CH₂—O]ₙ—R¹⁰ wherein n is an integer ranging from and including 1 up to an including 50, and wherein R¹⁰ is either H or an alkyl of 1 to 20 carbon atoms. The subject matter of this paragraph is mentioned in the specification as ‘A12’.

Preferably the aqueous coating composition is as disclosed in any one of A0 to A9 or as in any combination derived from the disclosure in this section and the entire specification including the claims, wherein the ethylenically unsaturated monomers different from carboxylic acid functional ethylenically unsaturated monomers [present in the acid-rich vinyl copolymer (A1) and the acid-poor vinyl copolymer (A2)], are selected from the group consisting of arylalkylenes, esters of itaconic acid, esters of acrylic acid of formula (1)

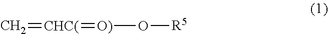

wherein R⁵ is either an optionally substituted alkyl of 1 to 20 carbon atoms, preferably of 1 to 8 carbon atoms, or a cycloalkyl of 5 to 12 ring carbon atoms,
esters of methacrylic acid of formula (2)

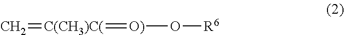

wherein R⁶ is either an optionally substituted alkyl of 1 to 20 carbon atoms, preferably of 1 to 8 carbon atoms, or a cycloalkyl of 5 to 12 ring carbon atoms,
polyalkylene oxide functionalized esters of acrylic acid of formula (3)

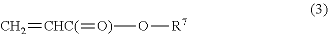

wherein R⁷ is either (CH₂CH₂—O)ₙ—R⁸ or [C(CH₃)CH₂—O]ₙ—R⁸, wherein n is an integer ranging from and including 1 up to an including 50, and wherein R⁸ is either H or an alkyl of 1 to 20 carbon atoms,
and polyalkylene oxide functionalized esters of methacrylic acid of formula (4)

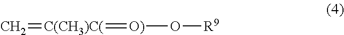

wherein R⁹ is either (CH₂CH₂—O)ₙ—R¹⁰ or [C(CH₃)CH₂—O]ₙ—R¹⁰ wherein n is an integer ranging from and including 1 up to an including 50, and wherein R¹⁰ is either H or an alkyl of 1 to 20 carbon atoms. The subject matter of this paragraph is mentioned in the specification as ‘A13’.

Preferably the aqueous coating composition is as disclosed in any one of A0 to A9 or as in any combination derived from the disclosure in this section and the entire specification including the claims, wherein the ethylenically unsaturated monomers different from carboxylic acid functional ethylenically unsaturated monomers [present in the acid-rich vinyl copolymer (A1) and the acid-poor vinyl copolymer (A2)], are selected from the group consisting of ethylenically unsaturated amides, vinyl esters, vinyl ethers, ethylenically unsaturated nitriles, heterocyclic vinyl compounds, diesters of fumaric acid, diesters of maleic acid, esters of acrylic acid of formula (1)

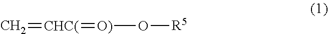

wherein R⁵ is either an optionally substituted alkyl of 1 to 20 carbon atoms, preferably of 1 to 8 carbon atoms, or a cycloalkyl of 5 to 12 ring carbon atoms,
esters of methacrylic acid of formula (2)

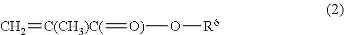

wherein R⁶ is either an optionally substituted alkyl of 1 to 20 carbon atoms, preferably of 1 to 8 carbon atoms, or a cycloalkyl of 5 to 12 ring carbon atoms. The subject matter of this paragraph is mentioned in the specification as ‘A14’.

Preferably the aqueous coating composition is as disclosed in any one of A0 to A14 or as in any combination derived from the disclosure in this section and the entire specification including the claims, wherein the ethylenically unsaturated monomers different from carboxylic acid functional ethylenically unsaturated monomers [present in the acid-rich vinyl copolymer (A1) and the acid-poor vinyl copolymer (A2)], are selected from the group consisting of diacetone acrylamide, allyl acetate, allyl chloroacetate, methallyl acetate, vinyl acetate, isopropenyl acetate, ethyl vinyl ether, acrylonitrile, methacrylonitrile, 1-vinylimidazole, dimethyl fumarate, diethyl fumarate, dimethyl maleate, diethyl maleate, dihydroxy alkyl (preferably an alkyl with 1 to 6 carbon atoms) adducts of fumaric acid, dihydroxy alkyl (preferably an alkyl with 1 to 6 carbon atoms) adducts of maleic acid, dihydroxy alkyl (preferably an alkyl with 1 to 6 carbon atoms) adducts of phthalic acid, styrene, α-methyl styrene, o-methyl styrene, m-methyl styrene, p-methyl styrene, pentachlorostyrene, o-chlorostyrene, m-chlorostyrene, p-chlorostyrene, p-cyanostyrene, methyl acrylate, ethyl acrylate, n-propyl acrylate, n-butyl acrylate, i-butyl acrylate, t-butyl acrylate, 2-octyl acrylate, 2-ethylhexyl acrylate, lauryl acrylate, isopropyl acrylate, cyclohexyl acrylate, 2-hydroxyethyl acrylate, 2-hydroxy-n-propyl acrylate 3-hydroxy-n-propyl acrylate, 4-hydroxy-n-butyl acrylate hydroxystearyl acrylate, methyl methacrylate, ethyl methacrylate, n-propyl methacrylate, isopropyl methacrylate, n-butyl methacrylate, i-butyl methacrylate, t-butyl methacrylate, cyclohexyl methacrylate, 2-ethylhexyl methacrylate, 2-octyl methacrylate, lauryl methacrylate, 2-hydroxyethyl methacrylate, 2-hydroxy-n-propyl methacrylate, 3-hydroxy-n-propyl methacrylate, 4-hydroxy-n-butyl methacrylate, hydroxystearyl methacrylate, Bisomer® PEA6, Bisomer® MPEG350MA, and mixtures thereof. The subject matter of this paragraph is mentioned in the specification as ‘A15’.

Preferably the aqueous coating composition is as disclosed in any one of A0 to A15 or as in any combination derived from the disclosure in this section and the entire specification including the claims, wherein the weight average molecular weight of the acid-rich vinyl copolymer (A1) determined via Size Exclusion Chromatography as described in the specification, is lower than the weight average molecular weight of the acid-poor vinyl copolymer (A2) determined via Size Exclusion Chromatography as described in the specification. The subject matter of this paragraph is mentioned in the specification as ‘A16’.

Preferably the aqueous coating composition is as disclosed in any one of A0 to A16 or as in any combination derived from the disclosure in this section and the entire specification including the claims, wherein the weight average molecular weight of the acid-rich vinyl polymer (A1) determined via Size Exclusion Chromatography (abbreviated as SEC) as disclosed in the specification, is at least 1000 and at most 70000, more preferably at least 3000 and at most 60000, even more preferably at least 5000 and at most 50000, most preferably at least 10000 and at most 40000 g/mol. The subject matter of this paragraph is mentioned in the specification as ‘A17’.

Preferably the aqueous coating composition is as disclosed in any one of A0 to A17 or as in any combination derived from the disclosure in this section and the entire specification including the claims, wherein the weight average molecular weight of the acid-poor vinyl polymer (A2) determined via Size Exclusion Chromatography (abbreviated as SEC) as disclosed in the specification, is at least 80000, more preferably at least 85000, most preferably at least 90000, especially at least 95000, more especially at least 100000 g/mol. The subject matter of this paragraph is mentioned in the specification as ‘A18’.

Preferably the aqueous coating composition is as disclosed in any one of A0 to A17 or as in any combination derived from the disclosure in this section and the entire specification including the claims, wherein the weight average molecular weight of the acid-poor vinyl polymer (A2) determined via Size Exclusion Chromatography as disclosed in the specification, is at least 80000 and at most such that the weight average molecular weight of the component (A) determined via Size Exclusion Chromatography as described in the specification, is at most 5000000, preferably at most 1000000, even more preferably at most 800000, most preferably at most 600000, especially at most 500000 g/mol; more preferably the weight average molecular weight of the acid-poor vinyl polymer (A2) determined via Size Exclusion Chromatography as disclosed in the specification, is at least 85000 and at most such that the weight average molecular weight of the component (A) determined via Size Exclusion Chromatography as described in the specification, is at most 5000000, preferably at most 1000000, even more preferably at most 800000, most preferably at most 600000, especially at most 500000 g/mol; even more preferably the weight average molecular weight of the acid-poor vinyl polymer (A2) determined via Size Exclusion Chromatography as disclosed in the specification, is at least 90000 and at most such that the weight average molecular weight of the component (A) determined via Size Exclusion Chromatography as described in the specification, is at most 5000000, preferably at most 1000000, even more preferably at most 800000, most preferably at most 600000, especially at most 500000 g/mol; most preferably the weight average molecular weight of the acid-poor vinyl polymer (A2) determined via Size Exclusion Chromatography as disclosed in the specification, is at least 95000 and at most such that the weight average molecular weight of the component (A) determined via Size Exclusion Chromatography as described in the specification, is at most 5000000, preferably at most 1000000, even more preferably at most 800000, most preferably at most 600000, especially at most 500000 g/mol; especially the weight average molecular weight of the acid-poor vinyl polymer (A2) determined via Size Exclusion Chromatography as disclosed in the specification, is at least 100000 and at most such that the weight average molecular weight of the component (A) determined via Size Exclusion Chromatography as described in the specification, is at most 5000000, preferably at most 1000000, even more preferably at most 800000, most preferably at most 600000, especially at most 500000 g/mol; The subject matter of this paragraph is mentioned in the specification as ‘A19’.

Preferably the aqueous coating composition is as disclosed in any one of A0 to A19 or as in any combination derived from the disclosure in this section and the entire specification including the claims, wherein the itaconates of the acid-rich vinyl copolymer (A1) and the itaconates of the acid-poor vinyl copolymer (A2) are selected from the group consisting of esters of itaconic acid and mixtures thereof, preferably from the group consisting of diesters of itaconic acid and mixtures thereof. The subject matter of this paragraph is mentioned in the specification as ‘A20’.

Preferably the aqueous coating composition is as disclosed in any one of A0 to A20 or as in any combination derived from the disclosure in this section and the entire specification including the claims, wherein the acid-poor vinyl copolymer (A2) comprises carboxylic acid functional ethylenically unsaturated monomers in an amount of from 0 to 2, and ethylenically unsaturated monomers different from carboxylic acid functional ethylenically unsaturated monomers, selected from the group consisting of acrylic esters, methacrylic esters, arylalkylenes and itaconates (preferably the itaconates are selected from the group consisting of esters of itaconic acid and mixtures thereof, more preferably the itaconates are selected from the group of diesters of itaconic acid, and mixtures thereof), in an amount of from 98 to 100 wt. % relative to the total weight of monomers charged in the polymerization to prepare the acid-poor vinyl copolymer (A2); more preferably the acid-poor vinyl copolymer (A2) comprises carboxylic acid functional ethylenically unsaturated monomers in an amount of from 0 to 1, and ethylenically unsaturated monomers different from carboxylic acid functional ethylenically unsaturated monomers, selected from the group consisting of acrylic esters, methacrylic esters, arylalkylenes and itaconates (preferably the itaconates are selected from the group consisting of esters of itaconic acid and mixtures thereof, more preferably the itaconates are selected from the group of diesters of itaconic acid, and mixtures thereof), in an amount of from 99 to 100 wt. % relative to the total weight of monomers charged in the polymerization to prepare the acid-poor vinyl copolymer (A2); even more preferably the acid-poor vinyl copolymer (A2) comprises carboxylic acid functional ethylenically unsaturated monomers in an amount of from 0 to 0.5, and ethylenically unsaturated monomers different from carboxylic acid functional ethylenically unsaturated monomers, selected from the group consisting of acrylic esters, methacrylic esters, arylalkylenes and itaconates (preferably the itaconates are selected from the group consisting of esters of itaconic acid and mixtures thereof, more preferably the itaconates are selected from the group of diesters of itaconic acid, and mixtures thereof), in an amount of from 99.5 to 100 wt. % relative to the total weight of monomers charged in the polymerization to prepare the acid-poor vinyl copolymer (A2); most preferably the acid-poor vinyl copolymer (A2) comprises carboxylic acid functional ethylenically unsaturated monomers in an amount of from 0 to 0.3, and ethylenically unsaturated monomers different from carboxylic acid functional ethylenically unsaturated monomers, selected from the group consisting of acrylic esters, methacrylic esters, arylalkylenes and itaconates (preferably the itaconates are selected from the group consisting of esters of itaconic acid and mixtures thereof, more preferably the itaconates are selected from the group of diesters of itaconic acid, and mixtures thereof), in an amount of from 99.7 to 100 wt. % relative to the total weight of monomers charged in the polymerization to prepare the acid-poor vinyl copolymer (A2); for example the acid-poor vinyl copolymer (A2) consists of ethylenically unsaturated monomers different from carboxylic acid functional ethylenically unsaturated monomers, selected from the group consisting of acrylic esters, methacrylic esters, arylalkylenes and itaconates (or in other words the acid-poor vinyl copolymer (A2) does not comprise any carboxylic acid functional ethylenically unsaturated monomers). The subject matter of this paragraph is mentioned in the specification as ‘A21’.

The aqueous coating composition of the invention may further comprise one or any combination of solvents, pigments, dyes, heat stabilizers, defoamers, fillers, matting agents, wetting agents, UV absorbers and antioxidants.

Preferably the aqueous coating composition is as disclosed in any one of A0 to A21 or as in any combination derived from the disclosure in this section and the entire specification including the claims, wherein the aqueous coating composition is an aqueous dispersion. The subject matter of this paragraph is mentioned in the specification as ‘A22’.

A dispersion refers to a system that has at least two phases where one phase contains discrete colloidally dispersed particles distributed throughout a bulk substance, the particles being the disperse phase and the bulk substance the continuous phase. In case of an aqueous dispersion, the continuous phase comprises water, preferably the continuous phase of an aqueous dispersion comprises water in at least 50, more preferably at least 75, even more preferably at least 80, most preferably at least 90, especially at least 95, more especially at least 98 wt. % relative to the continuous phase, for example the continues phase is water.

Preferably the aqueous coating composition is as disclosed in any one of A0 to A22 or as in any combination derived from the disclosure in this section and the entire specification including the claims, wherein the aqueous coating composition comprises a colloidal dispersion of particles which particles comprise the at least two vinyl polymers, namely
an acid-rich vinyl copolymer (A1) and
an acid-poor vinyl copolymer (A2),
   wherein said particles are dispersed in a continuous phase which continuous phase comprises water, preferably in an amount of at least at least 50, more preferably at least 75, more preferably at least 80, most preferably at least 90, especially at least 95, more especially at least 98 wt. % relative to the continuous phase, for example the continuous phase is water. The subject matter of this paragraph is mentioned in the specification as ‘A23’.

Preferably the aqueous coating composition is as disclosed in any one of A0 to A22 or as in any combination derived from the disclosure in this section and the entire specification including the claims, wherein the aqueous coating composition comprises a colloidal dispersion of particles which particles comprise the at least two vinyl polymers, namely
an acid-rich vinyl copolymer (A1) and
an acid-poor vinyl copolymer (A2),
   wherein said particles are dispersed in a continuous phase which continuous phase comprises water, preferably in an amount of at least at least 50, more preferably at least 75, more preferably at least 80, most preferably at least 90, especially at least 95, more especially at least 98 wt. % relative to the continuous phase, for example the continues phase is water, and wherein the colloidal dispersion of particles is anionically stabilized. The subject matter of this paragraph is mentioned in the specification as ‘A24’.

Preferably the aqueous coating composition is as disclosed in any one of A0 to A22 or as in any combination derived from the disclosure in this section and the entire specification including the claims, wherein the aqueous coating composition comprises a colloidal dispersion of particles which particles comprise the at least two vinyl polymers, namely
an acid-rich vinyl copolymer (A1) and
an acid-poor vinyl copolymer (A2),
   wherein said particles are dispersed in a continuous phase which continuous phase comprises water, preferably in an amount of at least at least 50, more preferably at least 75, more preferably at least 80, most preferably at least 90, especially at least 95, more especially at least 98 wt. % relative to the continuous phase, for example the continues phase is water, and wherein the acid-rich vinyl copolymer (A1) is at least partially deprotonated with a deprotonation agent A selected from the group constating of bases and mixtures thereof; more preferably the deprotonation agent A is selected from the group consisting of organic bases, inorganic bases and mixtures thereof; for example the deprotonation agent A is selected from the group consisting of organic amines, inorganic bases and mixtures thereof; for example the deprotonation agent A is selected from the group consisting of organic amines, ammonia, sodium hydroxide, potassium hydroxide, lithium hydroxide and mixtures thereof; for example the deprotonation agent A is selected from the group consisting of alkyl amines, alkanol amines, morpholine, ammonia, sodium hydroxide, potassium hydroxide, lithium hydroxide, and mixtures thereof; for example the deprotonation agent A is selected from the group consisting of triethyl amine, tributyl amine, ethanol amine, N-methyl ethanol amine, N,N-dimethyl ethanol amine, morpholine, ammonia, sodium hydroxide, potassium hydroxide, lithium hydroxide, and mixtures thereof; for example the deprotonation agent A is selected from the group consisting of triethyl amine, tributyl amine, ethanol amine, N-methyl ethanol amine, N,N-dimethyl ethanol amine, ammonia, sodium hydroxide, potassium hydroxide, lithium hydroxide, and mixtures thereof; for example the deprotonation agent A is selected from the group consisting of N,N-dimethyl ethanol amine, ammonia, sodium hydroxide, potassium hydroxide, lithium hydroxide, and mixtures thereof; for example the deprotonation agent A is selected from the group consisting of N,N-dimethyl ethanol amine, ammonia, sodium hydroxide, potassium hydroxide, and mixtures thereof; for example the deprotonation agent A is selected from the group consisting of N,N-dimethyl ethanol amine, ammonia, and mixtures thereof; for example the deprotonation agent A is selected from the group consisting of ammonia, organic amines, sodium hydroxide, potassium hydroxide and mixtures thereof; for example the deprotonation agent A is selected from the group consisting of ammonia, organic amines, and mixtures thereof; for example the deprotonation agent A is ammonia. The subject matter of this paragraph is mentioned in the specification as ‘A25’.

Preferably the aqueous coating composition is as disclosed in any one of A0 to A25 or as in any combination derived from the disclosure in this section and the entire specification including the claims, wherein the pH of the aqueous coating composition is at least 5.0 and at most 10.0, preferably at least 6.0 and at most 9.0, for example at least 6.5 and at most 9.0, for example at least 6.8 and at most 9.0. The subject matter of this paragraph is mentioned in the specification as ‘A26’.

Preferably the aqueous coating composition is as disclosed in any one of A0 to A26 or as in any combination derived from the disclosure in this section and the entire specification including the claims, wherein the aqueous coating composition comprises particles which particles comprise the at least two vinyl polymers, namely
an acid-rich vinyl copolymer (A1) and
an acid-poor vinyl copolymer (A2),
   wherein said particles are dispersed in a continuous phase which continuous phase comprises water, preferably in an amount of at least at least 50, more preferably at least 75, more preferably at least 80, most preferably at least 90, especially at least 95, more especially at least 98 wt. % relative to the continuous phase, for example the continues phase is water, and wherein the particles present in the aqueous coating composition have an average particle size determined via photon correlation spectroscopy as described in the specification, of at least 30 and at most 800, preferably at least 30 and at most 700, more preferably at least 30 and at most 600, for example at least 30 and at most 500, for example at least 30 and at most 400, for example at least 30 and at most 300, for example at least 30 and at most 250, for example at least 30 and at most 200, for example at least 40 and at most 800, for example at least 40 and at most 700, for example at least 40 and at most 600, for example at least 40 and at most 500, for example at least 40 and at most 400, for example at least 40 and at most 300, for example at least 40 and at most 250, for example at least 40 and at most 200, for example at least 50 and at most 800, for example at least 50 and at most 700, for example at least 50 and at most 600, for example at least 50 and at most 500, for example at least 50 and at most 400, for example at least 50 and at most 300, for example at least 50 and at most 250, for example at least 50 and at most 200, for example at least 60 and at most 800, for example at least 60 and at most 700, for example at least 60 and at most 600, for example at least 60 and at most 500, for example at least 60 and at most 400, for example at least 60 and at most 300, for example at least 60 and at most 250, for example at least 60 and at most 200 nm, and wherein the average particle size is the intensity-based average particle size (known as Z-average) determined via photon correlation spectroscopy as described in the specification. The subject matter of this paragraph is mentioned in the specification as ‘A27’.

Preferably the aqueous coating composition is as disclosed in any one of A0 to A27 or as in any combination derived from the disclosure in this section and the entire specification including the claims, wherein the aqueous coating composition comprises particles which particles comprise the at least two vinyl polymers, namely
an acid-rich vinyl copolymer (A1) and
an acid-poor vinyl copolymer (A2),
   wherein said particles are dispersed in a continuous phase which continuous phase comprises water, preferably in an amount of at least at least 50, more preferably at least 75, more preferably at least 80, most preferably at least 90, especially at least 95, more especially at least 98 wt. % relative to the continuous phase, for example the continues phase is water, and wherein the particles present in the aqueous coating composition have a particle size distribution determined via photon correlation spectroscopy as described in the specification, of at least 0.05 and at most 1.00, preferably at least 0.05 and at most 0.90, for example at least 0.05 and at most 0.80, for example at least 0.05 and at most 0.75, for example at least 0.10 and at most 1.00, for example at least 0.10 and at most 0.90, for example at least 0.10 and at most 0.80, for example at least 0.10 and at most 0.75. The subject matter of this paragraph is mentioned in the specification as ‘A28’.

The aqueous coating composition of the invention can be obtained by blending at least components (A), (B) and (C); preferably, the component (B) and/or the component (C) is/are incorporated into the aqueous coating composition by adding the component (B) and/or the component (C) prior to or during the preparation of the acid-rich vinyl copolymer (A1), or after the preparation of the acid-rich vinyl copolymer (A1) and prior to the preparation of the acid-poor vinyl copolymer (A2), or during the preparation of the acid-rich vinyl copolymer (A1) and that of the acid-poor vinyl copolymer (A2). More preferably, the components (B) and/or (C) are incorporated into the aqueous coating composition after the preparation of the acid-rich vinyl copolymer (A1) and prior to the preparation of the acid-poor vinyl copolymer (A2). Most preferably, the components (B) and/or (C) are incorporated into the aqueous coating composition either prior to the deprotonation of the acid-rich vinyl copolymer (A1) and prior to the preparation of the acid-poor vinyl copolymer (A2), or after the deprotonation of the acid-rich vinyl copolymer (A1) and prior to the preparation of the acid-poor vinyl copolymer (A2).

In an embodiment of the invention, there is provided a coating obtained upon drying the aqueous coating composition of the invention as this disclosed in any one of A0 to A28 or as in any combination derived from the disclosure in this section and the entire specification including the claims. The subject matter of this paragraph is mentioned in the specification as ‘A29’.

In an embodiment of the invention, there is provided a substrate which is at least partially coated with at least a coating as the coating is disclosed in A29 or as in any combination derived from the disclosure in this section and the entire specification including the claims. The subject matter of this paragraph is mentioned in the specification as ‘A30’.

Preferably the substrate is as disclosed in A30 or as in any combination derived from the disclosure in this section and the entire specification including the claims, wherein the substrate is paper. The subject matter of this paragraph is mentioned in the specification as ‘A31’.

Preferably the substrate is as disclosed in A30 or as in any combination derived from the disclosure in this section and the entire specification including the claims, wherein the substrate is a paperboard. The subject matter of this paragraph is mentioned in the specification as ‘A32’.

The specification also discloses a use of the aqueous coating compositions of the invention in coatings, paints, inks, varnishes, lubricants, adhesives, additive manufacturing, 3D-printing, textiles, waxes, fuels, photography, plastics, packaging e.g. food packaging, cement bags, medical devices, and in the preparation of medical compositions.

Further preferments and embodiments of the invention and preferred features thereof are given in the claims and in the Examples.

Unless otherwise explicitly stated, any feature, element, component, embodiment, range and especially any preferred feature, preferred element, preferred embodiment, preferred range, preferred combination of ranges, preferred substitutions, preferment described in the entire specification can be combined with each other. Unless otherwise explicitly stated, any feature, element, component, embodiment, range and especially any preferred feature, preferred element, preferred embodiment, preferred range, preferred combination of ranges, preferred substitutions, preferments, and embodiments in connection with any piece of disclosure in any one of A0 to A32 disclosed in this section can be combined with each other and with any other feature, element, component, embodiment, range and especially any preferred feature, preferred element, preferred embodiment, preferred range, preferred combination of ranges, preferred substitutions, preferments, and embodiments of the invention as these are disclosed in the entire specification including the claims. All combinations of minimum and maximum values of the parameters disclosed in this section may be used to define the parameter ranges for various preferments and embodiments of the invention disclosed in this section. Unless otherwise explicitly stated, any feature, element, component, embodiment, range and especially any preferred feature, preferred element, preferred embodiment, preferred range, preferred combination of ranges, preferred substitution, preferments, and embodiments of the invention as these are disclosed in this section, in the claims and in the entire specification can be combined with each other. For all upper and lower boundaries of any parameters given in this section, the boundary value is included in each range for each parameter. All combinations of minimum and maximum values of the parameters disclosed in this section may be used to define the parameter ranges for the various preferments and embodiments disclosed in this section.

### Examples

The invention is explained in more detail with reference to the following non-limiting examples which are by way of illustration only.

In the Examples section:
the abbreviation ‘I’ (followed by an indexing number) represents examples according to the invention;
the abbreviation ‘C’ (followed by an indexing number) represents examples not according to the invention;

By ‘inventive examples’ is meant in the specification examples which are according to the invention.

By ‘comparative examples’ is meant in the specification examples which are not according to the invention.

Unless otherwise specified, all the examples shown in this section were carried out in a controlled laboratory environment at standard conditions (defined in the specification), relative humidity of 50±5%, and airflow of ≤0.1 m/s.

### 1.1 Chemicals, Raw Materials and Other Materials Used in the Examples

n-butyl methacrylate (abbreviated as n-BMA), n-butyl acrylate (abbreviated as n-BA), ammonia solution 25% (25 wt. % of ammonia in demineralized water), ammonium persulphate and isoascorbic acid, were supplied from Sigma-Aldrich Merck. 2-octyl acrylate (abbreviated as 2-OA) was supplied from BASF. Ammonia solution 12.5% (12.5 wt. % of ammonia in demineralized water), and KOH solution 15% (15 wt. % of KOH in demineralized water) were prepared. BIT 10% (10 wt. % solution of benzisothiazolinone in demineralized water), supplied by Arxada, was used as a preservative.

### Polymers:

Indurez SR 10 PG [M_{w} determined via SEC according to the specification: 8947 g/mol; Indurez SR 10 PG was used as the acid-rich vinyl copolymer (A1) in all the examples; it consisted of 30 wt. % of acrylic acid, 45 wt. % styrene, 18 wt. % a-methyl styrene and 7 wt. % 2-ethylhexyl acrylate; information as offered by the supplier: solid, glycol-free styrene-acrylic resin, T_{g}=115° C., acid value=215-230 mg KOH/g] supplied from Indulor Chemie GmbH. Engage™ 8407 [information as offered by the supplier: ethylene-octene copolymer pellets (polyolefin elastomer), T_{g}=−54° C., melting temperature=60° C., density=0.870 g/cm³) supplied from Dow. Diofan® A050 [solids content (%) determined as described in the specification=58.4%; information as offered by the supplier: polyvinylidene chloride aqueous dispersion; pH=2.5-4.5, viscosity <40 mPa·s, boiling point ca. 100° C., melting point ca. 0° C., decomposition temperature >100° C.] supplied from Solvay S.A.

### Waxes:

### i) Waxes Free of Component (C):

Kester Wax K62 [information as offered by the supplier: product no. E00029 (synthetic ester wax of long chain saturated fatty alcohols and acids both of vegetable origin; it contains esters with carbon chain lengths between ca. C32-C46, especially C36-C44, congealing point=60-65° C., acid value=0-4 mg KOH/g, saponification value=89.5-98.5 mg KOH/g), Cera Bellina EU (abbreviated as Cera Bellina) [information as offered by the supplier: product no. E00168 is a polar beeswax derivative in which the free fatty acids of beeswax have been converted to polyglycerol esters, congealing point=63-73° C., acid value=<2 mg KOH/g, saponification value=84-98 mg KOH/g], were supplied from Koster Keunen Holland B.V.

The amount of component (C) of the Kester Wax K62 and the Cera Bellina, determined as described in the specification, was found to be 0.0% on wax. Thus, in examples shown in the specification where these two waxes were used, no component (C) amount was derived from them; in other words, in the specification both the Kester Wax K62 and the Cera Bellina were considered as free of component (C).

### ii) Waxes Containing Component (C):

Beeswax [information as offered by the supplier: white pastilles; product no. E00003; this natural animal wax is a complex mixture of ca. 70% non-glyceride esters (C38-C62), ca. 12-15% fatty acids (C16-C36) and ca. 12-16% paraffinic hydrocarbons (C21-C35), congealing point=61-65° C., drop melting point=61-66° C., acid value=17-24 mg KOH/g, ester value=70.0-80.0 mg KOH/g, saponification value=87-104 mg KOH/g, ratio=3.3-4.3, colour: white, yellow & light yellow], and Carnauba wax T1 flakes (abbreviated as Carnauba wax) [information as offered by the supplier: product no. E00018 is a natural wax obtained from leaves of a palm tree named Copernica cerifera and consists mainly of esters (ca. 85%), free long chain fatty alcohols (ca. 13%), and free fatty acids and resins, congealing point=appr. 82° C., melting range, class II=80-86° C., acid value=2-7 mg KOH/g, saponification value=78.0-95.0 mg KOH/g, ester value=71-88 mg KOH/g] were supplied from Koster Keunen Holland B.V.

### Commercial Products (Mixtures of Fatty Acids) Containing Component (C):

Radiacid® 0075 [information as offered by the supplier: high erucic based hydrogenated fatty acid (acid value=178-190 mg KOH/g, with C16-C18 fatty acids≤50%, C20-C22 fatty acids ≥50%, iodine value≤6 g I₂/100 g), Radiacid® 0565 (information as offered by the supplier: hydrogenated and fractionated long chain rapeseed-based fatty acid with typical C22 fatty acids content, with C16 fatty acids≤2%, C18 fatty acids≤5%, with C20 fatty acids≤9%, with C22 fatty acids ≥90%, acid value=158-168 mg KOH/g, iodine value≤2 g I₂/g, titer ≥75° C., boiling point=ca. 220° C., density at 20° C. ca. 890 kg/m³), Radiacid® 0560 [information as offered by the supplier: hydrogenated and fractionated long chain rapeseed-based fatty acid with typical C22 fatty acids content, with C16 fatty acids≤2%, with C18 fatty acids≤5%, with C20 fatty acids≤9%, with C22 fatty acids-86-89%, with C22:1 fatty acids≤1% and with C24 fatty acids≤2%, acid value=162-168 mg KOH/g, iodine value=1.3 g I₂/100 g, titer=74-79° C., boiling point >300° C., density at 20° C. ca. 890 kg/m³).

### Commercial Products (Mixtures of Fatty Acids) not Containing Component (C):

Radiacid® 0625 [information as offered by the supplier: distilled coconut oil fatty acid, with C8-C18 fatty acids, acid value=265-277 mg KOH/g, iodine value=7-11 g I₂/100 g, boiling point >150° C., density at 20° C. ca. 871 kg/m³] were supplied from Oleon®.

### Paper Substrate:

PackPro 7.0 [information as offered by the supplier: one side coated, wood-free flexible packaging paper with high surface quality, substance, according to ISO 536, 90 g/m²±4%; caliper single sheet, according to ISO 534, 73 μm±5%; brightness, according to ISO 2470, R457 D65, 86±2%) supplied from Brigl & Bergmeister.

### 1.2 Determination of the Number of Carbon Atoms of the Hydrocarbon Group of Fatty Acids (Abbreviated as the ‘HC Method’)

The number of carbon atoms of the hydrocarbon group of fatty acids present in an aqueous coating composition was determined via LC-MS (Liquid Chromatography Mass Spectroscopy) according to the following methodology.

A sample (1000±100 mg) of an aqueous coating composition was dissolved in 20 mL isopropyl alcohol, followed by 1:1 volume dilution with acetonitrile, to produce the analysis sample. The analysis sample was analyzed by using a LC system [Ultimate 3000 HPLC, supplied by Dionex] which was in-line with a MS system [Thermo Scientific™ Q Exactive™ Focus (orbitrap) supplied by Thermo Scientific]. The column used was Kinetex 2.6 μm EVO (C18 100 Å, 150×3.0 mm; supplied by Phenomenex) and it was combined with a precolumn [SecurityGuard ULTRA cartridge for EVO-C18 UHPLC, 10*3.0 mm (L* internal diameter) supplied by Phenomenex]. The column and precolumn were kept at 50° C. The parameters for the LC measurement were: injection volume: 1 μL; eluent flow 0.75 mL/min; eluent A was a mixture consisting of: 10 mM ammonium acetate, 0.1 v/v % acetic acid, and 95 v/v % water and 5 v/v % acetonitrile; the eluent B was a mixture consisting of: 10 mM ammonium acetate, 0.1 v/v % acetic acid and 95 v/v % water and 5 v/v % acetonitrile; the eluent C was mixture consisting of: 10 mM ammonium acetate, 0.1 v/v % acetic acid, and 90 v/v % isopropyl alcohol and 10 v/v % water. The gradient of eluents applied was as follows:
t=0 min; 90% A, 10% B,
t=1 min; 90% A, 10% B,
t=20 min; 1% A, 99% B,
t=25 min; 1% A, 29% B, 70% C,
t=30 min; 1% A, 29% B, 70% C,
t=35 min, completion.
   The eluate exiting the HPLC column was introduced into the in-line MS system. The MS system was set up as follows: MS m/z range was 105-1575 m/z, polarity: switching positive/negative; resolution 70000; the MS detection used both positive and negative mode, while negative mode is used for data analysis.

The outcome of this analysis was an individualized list of all C8 to C41 fatty acids (both saturated and unsaturated and including the carbon atom of the carboxylic acid group) present in the sample of the aqueous coating composition that provided for a direct identification and determination of the number of carbon atoms of the hydrocarbon group of fatty acids present in the sample of the aqueous coating composition.

### 1.3 Determination of the Amount of Component (C) (Abbreviated as the ‘CC Method’)

The amount of the component (C) present in an aqueous coating composition was determined via LC-MS (Liquid Chromatography Mass Spectroscopy) according to the following methodology.

A sample (1000±50 mg) of an aqueous coating composition was dissolved in 20 mL isopropyl alcohol, followed by 1:1 volume dilution with acetonitrile, to produce the analysis sample. The analysis sample was analyzed by using a LC system [Ultimate 3000 HPLC, supplied by Dionex] which was in-line with a MS system [Thermo Scientific™ Q Exactive™ Focus (orbitrap) supplied by Thermo Scientific]. The column used was Kinetex 2.6 μm EVO (C18 100 Å, 150×3.0 mm; supplied by Phenomenex) and it was combined with a precolumn [SecurityGuard ULTRA cartridge for EVO-C18 UHPLC, 10*3.0 mm (L* internal diameter) supplied by Phenomenex]. The column and precolumn were kept at 50° C. The parameters for the LC measurement were: injection volume: 1 μL; eluent flow 0.75 mL/min; eluent A was a mixture consisting of: 10 mM ammonium acetate, 0.1 v/v % acetic acid, and 95 v/v % water and 5 v/v % acetonitrile; the eluent B was a mixture consisting of: 10 mM ammonium acetate, 0.1 v/v % acetic acid and 95 v/v % water and 5 v/v % acetonitrile; the eluent C was mixture consisting of: 10 mM ammonium acetate, 0.1 v/v % acetic acid, and 90 v/v % isopropyl alcohol and 10 v/v % water. The gradient of eluents applied was as follows:
t=0 min; 90% A, 10% B,
t=1 min; 90% A, 10% B,
t=20 min; 1% A, 99% B,
t=25 min; 1% A, 29% B, 70% C,
t=30 min, 1% A, 29% B, 70% C,
t=35 min, completion.
   The eluate exiting the HPLC column was introduced into the in-line MS system. The MS system was set up as follows: MS m/z range was 105-1575 m/z, polarity: switching positive/negative; resolution 70000; the MS detection used both positive and negative mode, while negative mode is used for data analysis.

The outcome of this analysis was an individualized list of all C8 to C41 fatty acids (both saturated and unsaturated and including the carbon atom of the carboxylic acid group) present in the sample of the aqueous coating composition that provided for a direct identification and determination of the alkyl chain length of all fatty acids present in the sample of the aqueous coating composition, as well as their individual concentrations (%) relative to the total concentration of all the fatty acids present in the aqueous coating composition.

In order to determine the amount of component (C) in an aqueous coating composition, 10 reference combinations of varying and known concentrations of a mixture consisting of fatty acids C8 (octanoic acid; purity: ≥99%; CAS No.: 124-07-1; supplied by Supelco via Sigma Aldrich-Merck), C12 (lauric acid; purity: ≥98%; CAS No.: 143-07-7; supplied by Sigma Aldrich-Merck), C16 (palmitic acid; purity: ≥99%; CAS No.: 57-10-03; supplied by Sigma Aldrich-Merck), C18 (stearic acid; purity: ≥98.5%; CAS No.: 57-11-4; supplied by Sigma Aldrich-Merck), C20 (arachidic acid; purity: ≥99%; CAS No.: 506-30-9; supplied by Sigma Aldrich-Merck), C22 (behenic acid; purity: ≥98.5%; CAS No.: 112-85-6; supplied by Sigma Aldrich-Merck), C24 (lignoceric acid; purity: ≥99%; CAS No.: 557-59-5; supplied by Sigma Aldrich-Merck), and C26 (hexacosanoic acid; purity: ≥95%; CAS No.: 506-46-7; supplied by Sigma Aldrich-Merck) was each analyzed according to the methodology applied to analyze the sample of the aqueous coating composition. The outcome of this analysis provided for the response factor for each one of the C8, C12, C16, C18, C20, C22, C24, and C26 fatty acids present in the reference mixture.

The amount of the component (C) present in an aqueous coating composition (in weight amount per kg sample which is then used to determine the wt. % of component (C) present in the aqueous coating composition) was the sum of the individual amounts of all the fatty acids containing a carboxylic acid group at one end and a hydrocarbon group with at least 19 and at most 40 carbon atoms at the other end, as each one of the individual amounts of said fatty acids was determined on the basis of the response factor determined for each one of the C8, C12, C16, C18, C20, C22, C24, and C26 saturated fatty acids present in the reference mixture.

### 1.4 Determination of the Average Particle Size

The average particle size (as this in defined in the specification) was determined via photon correlation spectroscopy according to ISO 22412:2017, using a Malvern Zetasizer Nano S90. Samples were diluted in a solution of 1 mM potassium chloride in demineralized water to a concentration of approximately 0.1 g dispersion/l. A cuvette (clear 4-sided standard 5 mL, Dim. Ext. 12×12×45 mm from Kartell™) was filled between 10-15 mm with sample. Cuvette is placed in the holder fixed in position of the laser beam. Measurement temperature 25° C. Angle of laser light incidence 90°. Laser wavelength 633 nm.

The particle size distribution was determined as:
(peak width/peak height)².

The values reported for the average particle size and the particle size distribution were the average of 3 measurements.

### 1.5 Determination of the pH

The pH was measured using a WTW pH 3210 device from WTW GmbH with a 3M KCL combined pH glass electrode with a pH range 0 to 14 and temperature range 0 to 80° C. from Metrohm AG.

### 1.6 Determination of the Solids Content

The solids content (%) was determined using a halogen moisture analyzer HB43-S from Mettler Toledo. The measurement is based on the thermogravimetric principle. Prior to the measurement the moisture analyzer is leveled with the internal level indicator. The settings of the device were set for the drying temperature at 160° C. and the measurement lasted till the time of constant weight (the drying program was set to ‘STD’, the switch off mode to ‘3’, and the free factor to ‘off’). An aluminum disk with MN 85/90 filter paper (90 mm diameter) was put on the balance and zeroed. With a pipette 1.0±0.1 g of a sample of an aqueous coating composition was placed on the filter paper. At the start of the measurement the Moisture Analyzer determines the weight of the sample, the sample was then quickly heated by the integral halogen heating module and the volatile e.g. water, vaporize. During the drying process the instrument continually measures the weight of the sample and displays the reduction in volatiles. Once the drying was completed, the solids content of the sample was recorded.

### 1.7 Determination of the Weight Average Molecular Weight Via Size Exclusion Chromatography (Abbreviated as SEC)

The weight average molecular weight (M_{w}) [of component (A), acid-rich vinyl copolymer (A1) and acid-poor vinyl copolymer (A2)] was determined via Size Exclusion Chromatography (abbreviated as SEC) calibrated with a set of polystyrene standards with a molecular weight range of from 162 up to 7 ×10⁶ g/mol and using as an eluent stabilized tetrahydrofuran [THF with 0.02-0.03% w/w butyl-hydroxytoluene (BHT)] modified with 0.8% acetic acid, at a flow rate of 1 mL/min at 40° C. A polymer sample was dissolved/diluted in the eluent to obtain a concentration of 5 mg/ml. The sample was then stored at room temperature for 24 h; afterwards the sample was centrifuged for 30 min at 25000 relative centrifugal force, in an Eppendorf tube to isolate the soluble fraction. The supernatant was collected and transferred to a 1.5 mL vial (the solubility of the sample was judged visually with a laser pen). 100 μL of the collected supernatant sample was injected into the system. The SEC measurements were carried out on a Waters e2695 system which consisted of: i) a Waters 2414 Refractive Index detector at 40° C., ii) a Waters e2695 Separation Module equipped with a precolumn PLgel 5 μm Guard column with a length of 50 mm and an internal diameter of 7.5 mm and with two PLgel 5 μm Mixed C columns (mixed pore size) with an inner diameter of 7.5 mm, a length of 300 mm and a particle size of 5μ, all columns supplied by Agilent. The M_{w} was determined by the use of Empower version 3.6.1 software from Waters.

### 1.8 Determination of the Brookfield Viscosity

The Brookfield viscosity was determined using a Brookfield LV viscometer (60 rpm, room temperature; spindle 1 for viscosity 0-100 mPa·s, or spindle 2 for viscosity 100-500 mPa·s, or spindle 3 for viscosity 500-2000 mPa·s or spindle 4 for viscosity 2000-10000 mPa·s).

### 1.9 Assessment of the Water Barrier Properties of the Coatings

### 1.9.1. Determination of the Cobb₁₈₀₀

The Cobb₁₈₀₀ was determined according to DIN 53132:1981 and for a theoretical dry film thickness of 5±0.5 micron; the theoretical dry film thickness was calculated as follows:

$$Theoretical dry film thickness ( in micron ) = [ solids content ( \% ) of the aqueous coating composition ] * [ wet film thickness ( in micron ) ] .$$

For example, if an aqueous coating composition has 42% solids, in order to achieve a theoretical dry film thickness of 5 micron, a coating with a wet film thickness of approx. 12 micron (=5/0.42) has to be applied.

A sample of an aqueous coating composition was used to coat the uncoated side of a PackPro 7.0 paper (herein the ‘paper’) in order to prepare a coating with a theoretical dry film thickness of 5±0.5 micron; the side of the paper coated with the sample of the aqueous coating composition is mentioned as the AQ-coated side. The paper was then dried for 30 s in an oven at 80° C. and immediately afterwards was conditioned for 16 h at room temperature. A circular metal ring [with a height of 3 cm; an internal diameter of 5.6 cm; S_{ring} (internal surface of the ring)=25 cm²=0.0025 m²] was placed on the AQ-coated side and the external contour was marked with a pen and the circularly shaped sample was cut out. The cut out sample was weighed and its weight was recorded [M_{unexposed} (in g)]. The cut out sample was placed on a rubber mat with the AQ-coated side facing upwards, and the above mentioned circular metal ring was placed on it and secured into a fixed position with the help of clamps. 50 ml tap water at room temperature was poured onto the AQ-coated side and within the area defined by the circular metal ring. After 1800 s (at room temperature), from the time the water was poured onto the AQ-coated side, the water was poured out and the circular metal ring were removed; any residual water was removed carefully with a dry paper cloth. The sample exposed to water was weighed immediately and recorded [M_{exposed} (in g)]. The Cobb₁₈₀₀ value (in g·m⁻²) was calculated according to equation 1:

$${Cobb}_{1800} = ( {M}_{exposed} - {M}_{unexposed} ) * 400. \qquad ( equation 1 )$$

The Cobb₁₈₀₀ reported was the average of two measurements.

### 1.9.2. Determination of the Moisture Vapor Transmission Rate

The Moisture Vapor Transmission Rate (abbreviated as MVTR) was determined according to ASTM E96/E96M-16:2018 and for a theoretical dry film thickness of 5±0.5 micron; the theoretical dry film thickness was calculated as follows:

$$Theoretical dry film thickness ( in micron ) = [ solids content ( \% ) of the aqueous coating composition ] * [ wet film thickness ( in micron ) ] .$$

For example, if an aqueous coating composition has 42% solids, in order to achieve a theoretical dry film thickness of 5 micron, a coating with a wet film thickness of approx. 12 micron (=5/0.42) has to be applied.

A sample of an aqueous coating composition was used to coat the uncoated side of a PackPro 7.0 paper (herein the ‘paper’) in order to prepare a coating with a theoretical dry film thickness of 5±0.5 micron; the side of the paper coated with the sample of the aqueous coating composition is mentioned as the AQ-coated side. The paper was then dried for 30 s in an oven at 80° C. and immediately afterwards was conditioned for 16 h at room temperature. A thin layer of Vaseline™ was applied with the help of a cotton tip onto the edge of a 10-cm dish (surface area of 0.005 m²) equipped with a metal securing ring, and subsequently an amount of calcium chloride was placed into the dish to cover the bottom of the dish.

Subsequently, a 10-cm in diameter piece of the paper was punched out to fit the dish. Then the paper was placed onto the dish with the AQ-coated side facing upwards. A lid covered the dish and the lid and dish were secured into position by the securing ring forming a fixed unit. Afterwards, the weight of the unit was measured (WO).

The dish was placed in a humidity cabinet, which was maintained at 23° C. and 85% relative humidity. After 24 h, the unit was taken out from the humidity cabinet and its weight was recorded (W24)

The same procedure was applied this time for 96 h of the unit remained into the humidity cabinet. After 96 h, the unit was taken out from the humidity cabinet and its weight was recorded (W96).

The MVTR [reported in g·m⁻²·24 h⁻¹ (g per square meter per 24 h)] was calculated according to equation 2:

$$MVTR = ( MVTR 1 + MVTR 2 ) / 2 \qquad ( equation 2 )$$

$$wherein$$

$$MVTR 1 = 200 * ( W 24 - W 0 ) and MVTR 2 = 50 * ( W 96 - W 0 ) .$$

### 1.10 Determination of the Storage Stability of an Aqueous Coating Composition

100 g of a sample of an aqueous coating composition were placed in a glass jar; the glass jar was then closed with a lid and stored for 4 weeks in an oven at 40° C. When any one or any combination of sedimentation, creaming, phase separation, and gelation was observed during or at the end of the storage the storage period, the stability of the aqueous coating composition was characterized as ‘poor’. When no sedimentation, no creaming, no phase separation and no gelation were observed during or at the end of the storage period, the storage stability of the aqueous coating composition was characterized as ‘excellent’.

### 1.11 Preparation of Aqueous Coating Compositions

### 1.11.1. Preparation of Aqueous Coating Compositions According to the Invention (Inventive Aqueous Coating Compositions)

### Inventive Example 1 (Abbreviated as 11)

547.5 g of demineralized water were added to a 4-neck 2-liter round-bottom glass reactor equipped with a mechanical stirrer, a nitrogen inlet, a water condenser, two feeding funnels A and B, and a heating mantle. 123.9 g of Indurez SR 10 PG and 57.2 g of a mixture consisting of 80 wt. % of Kesterwax K62 and 20 wt. % of Radiacid 0075 were added under mechanical stirring followed by the addition of 40.1 g of ammonia solution 25%. Subsequently, the nitrogen-flow was set to 0.2 l/min and the condenser water was turned on. Afterwards, the reactor contents were heated up to 85° C. and thoroughly been mixed, until Indurez SR 10 PG was completely dissolved. The temperature of the reactor remained constant at 85° C. A mixture of 174.9 g of n-butyl methacrylate and 205.6 g of 2-octylacrylate, was added to the feeding funnel A. A solution of 6.2 g of ammonium persulphate dissolved in 90.4 g demineralized water and 1.8 g of ammonia solution 25%, were added to the feeding funnel B. A solution of 3.8 g of ammonium persulphate dissolved in 10.4 g demineralized water and 0.1 g of ammonia solution 25% were added to the reactor over a time period of 10 min and the reactor contents were mixed for additional 5 min. Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 19.7 g demineralized water were used to rinse the feeding funnel A. Subsequently, 1.2 g of ammonia solution 25% were added to the reaction mixture. Upon the completion of the addition of the contents of feeding funnel B, 3.5 g demineralized water were used to rinse the feeding funnel B. After the rinsing of the funnel B with demineralized water, stirring continued for another 60 min. The pH was adjusted by adding a solution of 5.8 g of ammonia solution 12.5% to the reactor and mixing was continued for additional 15 min. Afterwards, the reaction mixture was cooled down to 25° C., and subsequently, 3.5 g of BIT 10% and 4.4 g demineralized water were added to the reaction mixture and mixed for 15 min. Subsequently, the thus prepared aqueous coating composition was filtered through a 200 mesh screen.

The aqueous coating composition was an aqueous dispersion characterized as follows:
pH=8.1
solids content (%): 44.8.
Brookfield viscosity (mPa·s): 450.
weight amount (g) of vinyl acid-rich copolymer (A1): 123.9.
weight amount (g) of vinyl acid-poor copolymer (A2): 390.5.
Weight ratio of A1 to A2:25:75.
M_{w} of component (A): 123800 g/mol.
Amount of component B (g): 45.7 Amount of component C (g): 6.1.
Average particle size (Z-average; in nm) of the aqueous dispersion: 97.
Particle size distribution of the aqueous dispersion: 0.35.

### Inventive Example 2 (Abbreviated as 12)

505.3 g of demineralized water were added to a 4-neck 2-liter round-bottom glass reactor equipped with a mechanical stirrer, a nitrogen inlet, a water condenser, two feeding funnels A and B, and a heating mantle. 114.5 g of Indurez SR 10 PG, 45.0 g Beeswax and 7.9 g Radiacid 0565 were added under mechanical stirring followed by the addition of 36.2 g of ammonia solution 25%. Subsequently, the nitrogen-flow was set to 0.2 l/min and the condenser water was turned on. Afterwards, the reactor contents were heated up to 85° C. until Indurez SR 10 PG was completely dissolved. A mixture of 161.7 g n-butyl methacrylate and 190.0 g 2-octylacrylate was added to the feeding funnel A. A solution of 5.7 g of ammonium persulphate dissolved in 83.5 g demineralized water and 1.7 g of ammonia solution 25%, were added to the feeding funnel B. A solution of 3.5 g of ammonium persulphate dissolved in 9.6 g demineralized water and 0.1 g of ammonia solution 25% were added to the reactor over a time period of 15 min and 1.5 g of demineralized water was added to the reactor and the reactor contents were mixed for 5 min. Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 16.9 g demineralized water were used to rinse the feeding funnel A. Subsequently, 1.1 g of ammonia solution 25% were added to the reaction mixture. Upon the completion of the addition of the contents of feeding funnel B, 3.1 g demineralized water were used to rinse the feeding funnel B. After the rinsing of the funnel B with demineralized water, stirring continued for another 60 min. The pH was adjusted by adding a solution of 5.4 g of ammonia solution 12.5% to the reactor and mixing was continued for additional 15 min. Afterwards, the reaction mixture was cooled down to 25° C., and subsequently 3.3 g of BIT 10% and 4.1 g of demineralized water were added to the reaction mixture and mixed for 15 min. Subsequently, the thus prepared aqueous coating composition was filtered through a 200 mesh screen.

The aqueous coating composition was an aqueous dispersion characterized as follows:
pH=8.2.
Solids content (%): 45.1.
Brookfield viscosity (mPa·s): 180.
Weight amount (g) of vinyl acid-rich copolymer (A1): 171.8.
Weight amount (g) of vinyl acid-poor copolymer (A2): 541.4.
Weight ratio of A1 to A2:25:75.
M_{w} of component (A): 277600 g/mol.
Amount of component B (g): 61.8.
Amount of component C (g): 17.2.
Average particle size (Z-average; in nm) of the aqueous dispersion: 75.
Particle size distribution of the aqueous dispersion: 0.15.

### Inventive Example 3 (Abbreviated as 13)

501.0 g of demineralized water were added to a 4-neck 2-liter round-bottom glass reactor equipped with a mechanical stirrer, a nitrogen inlet, a water condenser, two feeding funnels A and B, and a heating mantle. 115.1 g of Indurez SR 10 PG and 45.2 g of Beeswax and 4.5 g of Radiacid 0560 were added under mechanical stirring followed by the addition of 37.7 g of an aqueous solution of ammonia (25 wt % in demineralized water). Subsequently, the nitrogen-flow was set to 0.2 l/min and the condenser water was turned on. Afterwards, the reactor contents were heated up to 85° C. and mixed until Indurez SR 10 PG was completely dissolved. A mixture of 162.5 g n-butyl methacrylate and 191.0 g 2-octyl acrylate was added to the feeding funnel A. A solution of 5.8 g of ammonium persulphate dissolved in 81.2 g of demineralized water and 0.5 g of an aqueous solution of ammonia (25 wt % in demineralized water) were added to the feeding funnel B. A solution of 3.5 g of ammonium persulphate dissolved in 8.3 g demineralized water and 0.1 g of ammonia solution 25% were added to the reactor over a time period of 15 min; subsequently, 1.4 g of demineralized water were added to the reactor and the reactor contents were mixed for 5 min. Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 14.9 g demineralized water were used to rinse the feeding funnel A. Subsequently, 1.2 g of ammonia solution 25% were added to the reaction mixture. Upon the completion of the addition of the contents of feeding funnel B, 2.7 g demineralized water were used to rinse the feeding funnel B. After the rinsing of the funnel B with demineralized water, stirring continued for another 60 min. Afterwards, the pH was adjusted by adding a solution of 5.4 g of ammonia solution 12.5% to the reactor and mixing was continued for additional 15 min. Afterwards, the reactor content was cooled down to 25° C. and while cooling a solution of 0.2 g of isoascorbic acid, 3.8 g of demineralized water and 0.1 g of ammonia solution 25% were added to the reactor, and mixing was continued for additional 30 min. Subsequently, 3.3 g of BIT 10% and 10.8 g of demineralized water were added to the reaction mixture and mixed for 15 min. Subsequently, the thus prepared aqueous coating composition was filtered through a 200 mesh screen.

The aqueous coating composition was an aqueous dispersion characterized as follows:
pH=8.2.
Solids content (%): 44.5.
Brookfield viscosity (mPa·s): 510.
Weight amount (g) of vinyl acid-rich copolymer (A1): 115.1.
Weight amount (g) of vinyl acid-poor copolymer (A2): 362.8.
Weight ratio of A1 to A2:25:75.
M_{w} of component (A): 126800 g/mol.
Amount of component B (g): 41.6.
Amount of component C (g): 8.0.
Average particle size (Z-average; in nm) of the aqueous dispersion: 127.
Particle size distribution of the aqueous dispersion: 0.64.

### Inventive Example 4 (Abbreviated as 14)

502.2 g of demineralized water were added to a 4-neck 2-liter round-bottom glass reactor equipped with a mechanical stirrer, a nitrogen inlet, a water condenser, two feeding funnels A and B, and a heating mantle. 109.9 g of Indurez SR 10 PG and 43.1 g of Beeswax and 28.0 g Radiacid 0560 was added under mechanical stirring followed by the addition of 42.4 g of ammonia solution 25%. Subsequently, the nitrogen-flow was set to 0.2 l/min and the condenser water was turned on. Afterwards, the reactor contents were heated to 85° C. and mixed until Indurez SR 10 PG was completely dissolved. A mixture of 155.2 g of n-butyl methacrylate and 182.4 g of 2-octyl acrylate was added to the feeding funnel A. A solution of 5.5 g of ammonium persulphate dissolved in 77.6 g of demineralized water and 0.5 g of ammonia solution 25% were added to the feeding funnel B. A solution of 3.4 g ammonium persulphate dissolved in 7.9 g demineralized water and 0.1 g of ammonia solution 25% were added to the reactor over a time period of 15 min and 1.3 g of demineralized water is added to the reactor and the reactor contents were mixed for 5 min. Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 14.2 g demineralized water were used to rinse the feeding funnel A. Subsequently, 1.1 g of ammonia solution 25% were added to the reaction mixture. Upon the completion of the addition of the contents of feeding funnel B, 2.6 g demineralized water were used to rinse the feeding funnel B. After the rinsing of the funnel B with demineralized water, stirring continued for another 60 min. The pH was adjusted by adding a solution of 5.2 g of ammonia solution 12.5% into the reactor and mixing continued for additional 15 min. Afterwards, the reactor content was cooled down to 25° C. and a solution of 0.2 g of isoascorbic acid, 3.0 g of demineralized water and 0.1 g of ammonia solution 25% were added and mixing was continued for 30 min. Subsequently, 3.2 g of BIT 10% and 12.2 g of demineralized water were added to the reaction mixture and mixed for 15 min. Subsequently, the thus prepared aqueous coating composition was filtered through a 200 mesh screen.

The aqueous coating composition was an aqueous dispersion characterized as follows:
pH=8.2.
Solids content (%): 45.3.
Brookfield viscosity (mPa·s): 525.
Weight amount (g) of vinyl acid-rich copolymer (A1): 109.9.
Weight amount (g) of vinyl acid-poor copolymer (A2): 346.5.
Weight ratio of A1 to A2:25:75.
M_{w} of component (A): 95100 g/mol.
Amount of component B (g): 39.6
Amount of component C (g): 30.9.
Average particle size (Z-average; in nm) of the aqueous dispersion: 94.
Particle size distribution of the aqueous dispersion: 0.28.

### Inventive Example 5 (Abbreviated as 15)

502.5 g of demineralized water were added to a 4-neck 2-liter round-bottom glass reactor equipped with a mechanical stirrer, a nitrogen inlet, a water condenser, two feeding funnels A and B, and a heating mantle. 107.7 g of Indurez SR 10 PG and 42.3 g of Beeswax and 38.1 g Radiacid 0560 was added under mechanical stirring followed by the addition of 44.8 g of ammonia solution 25%. Subsequently, the nitrogen-flow was set to 0.2 l/min and the condenser water was turned on. Afterwards, the reactor contents were heated to 85° C. and mixed until Indurez SR 10 PG was completely dissolved. A mixture of 152.0 g of n-butyl methacrylate and 178.7 g of 2-octyl acrylate was added to the feeding funnel A. A solution of 5.4 g of ammonium persulphate dissolved in 76.0 g of demineralized water and 0.5 g of ammonia solution 25% were added to the feeding funnel B. A solution of 3.3 g ammonium persulphate dissolved in 7.7 g demineralized water and 0.1 g of ammonia solution 25% were added to the reactor over a time period of 15 min and 1.3 g of demineralized water is added to the reactor and the reactor contents were mixed for 5 min. Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 13.9 g demineralized water were used to rinse the feeding funnel A. Subsequently, 1.1 g of ammonia solution 25% were added to the reaction mixture. Upon completion of the addition of the contents of feeding funnel B, 2.5 g demineralized water were used to rinse the feeding funnel B. After the rinsing of the funnel B with demineralized water, stirring continued for another 60 min. The pH was adjusted by adding a solution of 5.0 g of ammonia solution 12.5% to the reactor and mixing continued for additional 15 min. Afterwards, the reactor content was cooled down to 25° C. and a solution of 0.2 g of isoascorbic acid, 3.0 g of demineralized water and 0.1 g of ammonia solution 25% were added and mixing was continued for 30 min. Subsequently, 3.2 g of BIT and 10.0 g of demineralized water were added to the reaction mixture and mixed for 15 min. Subsequently, the thus prepared aqueous coating composition was filtered through a 200 mesh screen.

The aqueous coating composition was an aqueous dispersion characterized as follows:
pH=8.2.
Solids content (%): 44.9.
Brookfield viscosity (mPa·s): 189.
Weight amount (g) of vinyl acid-rich copolymer (A1): 107.7.
Weight amount (g) of vinyl acid-poor copolymer (A2): 339.4.
Weight ratio of A1 to A2:25:75.
M_{w} of component (A): 87700 g/mol.
Amount of component B (g): 38.9
Amount of component C (g): 40.8.
Average particle size (Z-average; in nm) of the aqueous dispersion: 87.
Particle size distribution of the aqueous dispersion: 0.30.

### Inventive Example 6 (Abbreviated as 16)

500.0 g of demineralized water were added to a 4-neck 2-liter round-bottom glass reactor equipped with a mechanical stirrer, a nitrogen inlet, a water condenser, two feeding funnels A and B, and a heating mantle. 115.8 g of Indurez SR 10 PG and 39.0 g of Cera Bellina and 7.8 g Radiacid 0560 was added under mechanical stirring followed by the addition of 37.9 g of an aqueous solution of ammonia (25 wt. % in demineralized water). Subsequently, the nitrogen-flow was set to 0.2 l/min and the condenser water was turned on. Afterwards, the reactor contents were heated to 85° C. and mixed until Indurez SR 10 PG was completely dissolved. A mixture of 163.5 g of n-butyl methacrylate and 192.1 g of 2-octyl acrylate was added to the feeding funnel A. A solution of 5.8 g of ammonium persulphate dissolved in 81.7 g of demineralized water and 0.6 g of ammonia solution 25% were added to the feeding funnel B. A solution of 3.6 g ammonium persulphate dissolved in 8.3 g demineralized water and 0.1 g of ammonia solution 25% were added to the reactor over a time period of 15 min and 1.4 g of demineralized water is added to the reactor and the reactor contents were mixed for 5 min. Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 15.0 g demineralized water were used to rinse the feeding funnel A. Subsequently, 1.2 g of ammonia solution 25% were added to the reaction mixture. Upon the completion of the addition of the contents of feeding funnel B, 2.7 g demineralized water were used to rinse the feeding funnel B. After the rinsing of the funnel B with demineralized water, stirring continued for another 60 min. The pH was adjusted by adding a solution of 5.4 g of ammonia solution 12.5% to the reactor and mixing continued for additional 15 min. Afterwards, the reactor content was cooled down to 25° C. and a solution of 0.2 g of isoascorbic acid, 3.8 g of demineralized water and 0.1 g of ammonia solution 25% were added and mixing was continued for 30 min. Subsequently, 3.3 g of BIT 10% and 10.9 g of demineralized water were added to the reaction mixture and mixed for 15 min. Subsequently, the thus prepared aqueous coating composition was filtered through a 200 mesh screen.

The aqueous coating composition was an aqueous dispersion characterized as follows:
pH=8.2.
Solids content (%): 44.6.
Brookfield viscosity (mPa·s): 204.
Weight amount (g) of vinyl acid-rich copolymer (A1): 115.8.
Weight amount (g) of vinyl acid-poor copolymer (A2): 365.0.
Weight ratio of A1 to A2:25:75.
M_{w} of component (A): 124100 g/mol.
Amount of component B (g): 32.5
Amount of component C (g): 7.7.
Average particle size (Z-average; in nm) of the aqueous dispersion: 85.
Particle size distribution of the aqueous dispersion: 0.19.

### Inventive Example 7 (Abbreviated as 17)

505.6 g of demineralized water were added to a 4-neck 2-liter round-bottom glass reactor equipped with a mechanical stirrer, a nitrogen inlet, a water condenser, two feeding funnels A and B, and a heating mantle. 110.1 g of Indurez SR 10 PG and 37.1 g of Cera Bellina and 33.4 g Radiacid 0560 was added under mechanical stirring followed by the addition of 38.9 g of an aqueous solution of ammonia (25 wt. % in demineralized water). Subsequently, the nitrogen-flow was set to 0.2 l/min and the condenser water was turned on. Afterwards, the reactor contents were heated to 85° C. and mixed until Indurez SR 10 PG was completely dissolved. A mixture of 155.4 g of n-butyl methacrylate and 182.7 g of 2-octyl acrylate was added to the feeding funnel A. A solution of 5.5 g of ammonium persulphate dissolved in 77.7 g of demineralized water and 0.5 g of ammonia solution 25% were added to the feeding funnel B. A solution of 3.4 g ammonium persulphate dissolved in 7.9 g demineralized water and 0.1 g of ammonia solution 25% were added to the reactor over a time period of 15 min and 1.4 g of demineralized water is added to the reactor and the reactor contents were mixed for 5 min. Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 14.2 g demineralized water were used to rinse the feeding funnel A. Subsequently, 1.3 g of ammonia solution 25% were added to the reaction mixture. Upon the completion of the addition of the contents of feeding funnel B, 2.6 g demineralized water were used to rinse the feeding funnel B. After the rinsing of the funnel B with demineralized water, stirring continued for another 60 min. The pH was adjusted by adding a solution of 5.2 g of ammonia solution 12.5% to the reactor and mixing continued for additional 15 min. Afterwards, the reactor content was cooled down to 25° C. and a solution of 0.2 g of isoascorbic acid, 3.7 g of demineralized water and 0.1 g of ammonia solution 25% were added and mixing was continued for 30 min. Subsequently, 3.2 g of BIT 10% and 10.3 g of demineralized water were added to the reaction mixture and mixed for 15 min. Subsequently, the thus prepared aqueous coating composition was filtered through a 200 mesh screen.

The aqueous coating composition was an aqueous dispersion characterized as follows:
pH=8.2.
Solids content (%): 44.6.
Brookfield viscosity (mPa·s): 517.
Weight amount (g) of vinyl acid-rich copolymer (A1): 110.1.
Weight amount (g) of vinyl acid-poor copolymer (A2): 347.0.
Weight ratio of A1 to A2:25:75.
M_{w} of component (A): 88000 g/mol.
Amount of component B (g): 37.1.
Amount of component C (g): 32.8.
Average particle size (Z-average; in nm) of the aqueous dispersion: 94.
Particle size distribution of the aqueous dispersion: 0.21.

### 1.11.2. Preparation of Aqueous Coating Compositions not According to the Invention (Comparative Aqueous Coating Compositions)

### Comparative Example 1 (Abbreviated as C1)

1145.0 g of demineralized water were added to a 4-neck 3-liter round-bottom glass reactor equipped with a mechanical stirrer, a nitrogen inlet, a water condenser, two feeding funnels A and B, and a heating mantle. 297.2 g of Indurez SR 10 PG, and 95.5 g of ammonia solution 25% were added under mechanical stirring. Subsequently, the nitrogen-flow was set to 0.2 l/min and the condenser water was turned on. The reactor contents were heated up to 85° C. and mixed until Indurez SR 10 PG was completely dissolved. A mixture of 419.6 g of n-butyl methacrylate, 493.2 g of 2-octylacrylate and 55.7 g of demineralized water was added to the feeding funnel A. A solution of 14.9 g of ammonium persulphate dissolved in 209.8 g of demineralized water and 0.4 g of ammonia solution 25% was added to feeding funnel B. A solution of 9.2 g of ammonium persulphate dissolved in 21.3 g of demineralized water and 0.2 g of ammonia solution 25% was added to the reactor in 15 min and 3.5 g of demineralized water was added to the reactor and the reactor contents were mixed for 5 min. Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 55.7 g demineralized water were used to rinse the feeding funnel A. Subsequently, 2.8 g of ammonia solution 25% were added to the reaction mixture. Upon the completion of the addition of the contents of feeding funnel B, 7.0 g demineralized water were used to rinse the feeding funnel B. After the rinsing of the funnel B with demineralized water, stirring continued for another 60 min. The pH was adjusted by adding a solution of 14.0 g of ammonia solution 12.5% to the reactor and mixing was continued for additional 15 min. Afterwards, the reaction mixture was cooled down to 25° C., and subsequently 8.4 g of BIT 10% and 3.5 g demineralized water were added to the reaction mixture and mixed for 15 min. Subsequently, the thus prepared aqueous coating composition was filtered through a 200 mesh screen.

The aqueous coating composition was an aqueous dispersion characterized as follows:
pH=8.5.
Solids content (%): 44.0.
Brookfield viscosity (mPa·s): 400.
Weight amount (g) of vinyl acid-rich copolymer (A1): 297.2.
Weight amount (g) of vinyl acid-poor copolymer (A2): 936.9.
Weight ratio of A1 to A2:25:75.
M_{w} of component (A): 171200 g/mol.
Amount of component B (g): 0.
Amount of component C (g): 0.
Average particle size (Z-average; in nm) of the aqueous dispersion: 90.
Particle size distribution of the aqueous dispersion: 0.15.

### Comparative Example 2 (Abbreviated as C2)

573.4 g of demineralized water were added to a 4-neck 2-liter round-bottom glass reactor equipped with a mechanical stirrer, a nitrogen inlet, a water condenser, two feeding funnels A and B, and a heating mantle. 136.3 g of Indurez SR 10 PG and 63.0 g Carnauba wax were added under mechanical stirring followed by the addition of 43.8 g of an aqueous solution of ammonia (25 wt. % in demineralized water). Subsequently, the nitrogen-flow was set to 0.2 I/min and the condenser water was turned on. Afterwards, the reactor contents were heated up to 85° C. until Indurez SR 10 PG was completely dissolved. A mixture of 193.2 g of n-butyl methacrylate and 226.1 g of n-butyl acrylate was added to the feeding funnel A. A solution of 6.8 g of ammonium persulphate dissolved in 91.9 g of demineralized water and 4.5 g of an aqueous solution of ammonia (25 wt. % of ammonia in demineralized water), were added to the feeding funnel B. A solution of 4.2 g of ammonium persulphate dissolved in 9.8 g demineralized water and 0.1 g of ammonia solution 25% were added to the reactor over a time period of 2 min and 1.6 g of demineralized water was added to the reactor and the reactor contents were mixed for 5 min. Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 22.5 g demineralized water were used to rinse the feeding funnel A. Subsequently, 1.3 g of ammonia solution 25% were added to the reaction mixture. Upon the completion of the addition of the contents of feeding funnel B, 6.4 g demineralized water were used to rinse the feeding funnel B. After the rinsing of the funnel B with demineralized water, stirring continued for another 60 min. The pH was adjusted by adding a solution of 6.4 g of an aqueous solution of ammonia (12.5 wt % solution in demineralized water) to the reactor and mixing was continued for additional 15 min. Afterwards, the reaction mixture was cooled down to 25° C., and subsequently 3.9 g of BIT 10% and 4.8 g of demineralized water were added to the reaction mixture and mixed for 15 min. Subsequently, the thus prepared aqueous coating composition was filtered through a 200 mesh screen.

The aqueous coating composition was an aqueous dispersion characterized as follows:
pH=8.6.
Solids content (%): 45.8.
Brookfield viscosity (mPa·s): 568.
Weight amount (g) of vinyl acid-rich copolymer (A1): 136.3
Weight amount (g) of vinyl acid-poor copolymer (A2): 430.4
Weight ratio of A1 to A2:25:75.
M_{w} of component (A): 132600 g/mol.
Amount of component B (g): 59.9.
Amount of component C (g): 3.1.
Average particle size (Z-average; in nm) of the aqueous dispersion: 83.
Particle size distribution of the aqueous dispersion: 0.13.

### Comparative Example 3 (Abbreviated as C3)

546.4 g of demineralized water were added to a 4-neck 3-liter round-bottom glass reactor equipped with a mechanical stirrer, a nitrogen inlet, a water condenser, two feeding funnels A and B, and a heating mantle. 123.9 g of Indurez SR 10 PG, 57.2 g of a mixture consisting of 80 wt. % of Kesterwax K62 and 20 wt. % of Radiacid 0625 and 41.1 g of ammonia solution 25% were added under mechanical stirring. Subsequently, the nitrogen-flow was set to 0.2 l/min and the condenser water was turned on. The reactor contents were heated up to 85° C. and mixed until Indurez SR 10 PG was completely dissolved. A mixture of 174.9 g of n-butyl methacrylate and 205.6 g of 2-octylacrylate was added to the feeding funnel A. A solution of 6.2 g of ammonium persulphate dissolved in 90.4 g of demineralized water and 1.8 g of ammonia solution 25% was added to feeding funnel B. A solution of 3.8 g of ammonium persulphate dissolved in 10.4 g of demineralized water and 0.1 g of ammonia solution 25% was added to the reactor in 10 min and the reactor contents were mixed for 5 min.

Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 19.7 g demineralized water were used to rinse the feeding funnel A. Subsequently, 1.2 g of ammonia solution 25% were added to the reaction mixture. Upon the completion of the addition of the contents of feeding funnel B, 3.5 g demineralized water were used to rinse the feeding funnel B. After the rinsing of the funnel B with demineralized water, stirring continued for another 60 min. The pH was adjusted by adding a solution of 5.8 g of ammonia solution 12.5% to the reactor and mixing was continued for additional 15 min. Afterwards, the reaction mixture was cooled down to 25° C., and subsequently 3.5 g of BIT 10% and 4.4 g of demineralized water were added to the reaction mixture and mixed for 15 min. subsequently, the thus prepared aqueous coating composition was filtered through a 200 mesh screen.

The aqueous coating composition was an aqueous dispersion characterized as follows:
pH=8.1.
Solids content (%): 45.2.
Brookfield viscosity (mPa·s): 142.
Weight amount (g) of vinyl acid-rich copolymer (A1): 123.9.
Weight amount (g) of vinyl acid-poor copolymer (A2): 390.5.
Weight ratio of to A1 to A2:25:75.
M_{w} of component (A): 140500 g/mol.
Amount of component B (g): 45.8.
Amount of component C (g): 0.05.
Average particle size (Z-average; in nm) of the aqueous dispersion: 84.
Particle size distribution of the aqueous dispersion: 0.11.

### Comparative Example 4 (Abbreviated as C4)

The comparative aqueous coating composition 3 was prepared by mixing constituents X and Y according to the following procedure.

Preparation of constituent X: 1145.0 g of demineralized water were added to a 4-neck 3-liter round-bottom glass reactor equipped with a mechanical stirrer, a nitrogen inlet, a water condenser, two feeding funnels A and B, and a heating mantle. 297.2 g of Indurez SR 10 PG and 95.5 g of ammonia solution 25% were added under mechanical stirring. Subsequently, the nitrogen-flow was set to 0.2 l/min and the condenser water was turned on. The reactor contents were heated up to 85° C. and mixed until Indurez SR 10 PG was completely dissolved. A mixture of 419.6 g of n-butyl methacrylate, 493.2 g of 2-octylacrylate and 55.7 g of demineralized water was added to the feeding funnel A. A solution of 14.9 g of ammonium persulphate dissolved in 209.8 g of demineralized water and 0.4 g of ammonia solution 25% were added to feeding funnel B. A solution of 9.2 g of ammonium persulphate dissolved in 21.3 g of demineralized water and 0.2 g were added to the reactor in 15 min and 3.5 g of demineralized water was added to the reactor and the reactor contents were mixed for 5 min. Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 55.7 g demineralized water were used to rinse the feeding funnel A. Subsequently, 2.8 g of ammonia solution 25% were added to the reaction mixture. Upon the completion of the addition of the contents of feeding funnel B, 7.0 g demineralized water were used to rinse the feeding funnel B. After the rinsing of the funnel B with demineralized water, stirring continued for another 60 min. The pH was adjusted by adding a solution of 14.0 g of ammonia solution 12.5% to the reactor and mixing was continued for additional 15 min. Afterwards, the reaction mixture was cooled down to 25° C., and subsequently 8.4 g of BIT 10% and 3.5 g of demineralized water were added to the reaction mixture and mixed for 15 min. Subsequently, the thus prepared aqueous coating composition was filtered through a 200 mesh screen.

Preparation of constituent Y: 131.9 g of demineralized water were added to a 250 ml glass flange reactor equipped with a mechanical stirrer, a water condenser and a heating mantle. 86.2 g of Beeswax and 8.7 g of KOH solution 15% were added under mechanical stirring and 6.2 g of demineralized water was added to the reaction mixture. The condenser water was turned on and the reaction mixture was heated up to 70° C. and temperature maintained for 40 min. The reaction mixture was cooled down to 25° C. Subsequently, the aqueous wax dispersion was filtered through a 25 micron filter.

1571 g of constituent X and 4.7 g of demineralized water were loaded into a 4-neck 2-liter round-bottom glass reactor equipped with a mechanical stirrer and which reactor was kept at room temperature. Subsequently, 219.5 g of constituent Y and 4.7 g of demineralized water were added to the reactor under continuous stirring. The mixing of the mixture was continued for additional 60 min. Subsequently, the thus prepared aqueous coating composition was filtered through a 200 mesh screen.

The aqueous coating composition was an aqueous dispersion characterized as follows:
pH=8.5.
Solids content (%): 41.5.
Brookfield viscosity (mPa·s): 60.
Weight amount (g) of vinyl acid-rich copolymer (A1): 166.1.
Weight amount (g) of vinyl acid-poor copolymer (A2): 523.7.
Weight ratio of to A1 to A2:25:75.
M_{w} of component (A): 667000 g/mol.
Amount of component B (g): 71.2.
Amount of component C (g): 6.3.
Average particle size (Z-average; in nm) of the aqueous dispersion: 132.
Particle size distribution of the aqueous dispersion: 0.56.

### Comparative Example 5 (Abbreviated as C5)

502.8 g of demineralized water were added to a 4-neck 2-liter round-bottom glass reactor equipped with a mechanical stirrer, a nitrogen inlet, a water condenser, two feeding funnels A and B, and a heating mantle. 105.2 g of Indurez SR 10 PG and 41.3 g of Beeswax and 49.5 g Radiacid 0560 was added under mechanical stirring followed by the addition of 47.3 g of an aqueous solution of ammonia (25 wt. % in demineralized water). Subsequently, the nitrogen-flow was set to 0.2 l/min and the condenser water was turned on. Afterwards, the reactor contents were heated to 85° C. and mixed until Indurez SR 10 PG was completely dissolved. A mixture of 148.5 g of n-butyl methacrylate and 174.5 g of 2-octyl acrylate was added to the feeding funnel A. A solution of 5.3 g of ammonium persulphate dissolved in 74.2 g of demineralized water and 0.5 g of ammonia solution 25% were added to the feeding funnel B. A solution of 3.2 g ammonium persulphate dissolved in 7.5 g demineralized water and 0.1 g of ammonia solution 25% were added to the reactor over a time period of 15 min and 1.2 g of demineralized water is added to the reactor and the reactor contents were mixed for 5 min. Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 13.6 g demineralized water were used to rinse the feeding funnel A. Subsequently, 1.1 g of ammonia solution 25% were added to the reaction mixture. Upon the completion of the addition of the contents of feeding funnel B, 2.5 g demineralized water were used to rinse the feeding funnel B. After the rinsing of the funnel B with demineralized water, stirring continued for another 60 min. The pH was adjusted by adding a solution of 5.0 g of ammonia solution 12.5% to the reactor and mixing continued for additional 15 min. Afterwards, the reactor content was cooled down to 25° C. and a solution of 0.2 g of isoascorbic acid, 3.5 g of demineralized water and 0.1 g of ammonia solution 25% were added and mixing was continued for 30 min. Subsequently, 3.2 g of BIT 10% and 9.9 g of demineralized water were added to the reaction mixture and mixed for 15 min. Subsequently, the thus prepared aqueous coating composition was filtered through a 200 mesh screen.

The aqueous coating composition was an aqueous dispersion characterized as follows:
pH=8.4.
Solids content (%): 44.2.
Brookfield viscosity (mPa·s): 765.
Weight amount (g) of vinyl acid-rich copolymer (A1): 105.2.
Weight amount (g) of vinyl acid-poor copolymer (A2): 331.5.
Weight ratio of to A1 to A2:25:75.
M_{w} of component (A): 85600 g/mol.
Amount of component B (g): 37.9.
Amount of component C (g): 51.9.
Average particle size (Z-average; in nm) of the aqueous dispersion: 169.
Particle size distribution of the aqueous dispersion: 0.99.

### Comparative Example 6 (Abbreviated as C6)

497.5 g of demineralized water were added to a 4-neck 2-liter round-bottom glass reactor equipped with a mechanical stirrer, a nitrogen inlet, a water condenser, two feeding funnels A and B, and a heating mantle. 117.4 g of Indurez SR 10 PG and 39.5 g of Cera Bellina and 0.4 g Radiacid 0560 was added under mechanical stirring followed by the addition of 38.5 g of an aqueous solution of ammonia (25 wt. % in demineralized water). Subsequently, the nitrogen-flow was set to 0.2 l/min and the condenser water was turned on. Afterwards, the reactor contents were heated to 85° C. and mixed until Indurez SR 10 PG was completely dissolved. A mixture of 165.8 g of n-butyl methacrylate and 194.9 g of 2-octyl acrylate was added to the feeding funnel A. A solution of 5.9 g of ammonium persulphate dissolved in 82.9 g of demineralized water and 0.6 g of ammonia solution 25% were added to the feeding funnel B. A solution of 3.6 g ammonium persulphate dissolved in 8.4 g demineralized water and 0.1 g of ammonia solution 25% were added to the reactor over a time period of 15 min and 1.4 g of demineralized water is added to the reactor and the reactor contents were mixed for 5 min. Subsequently the contents of the feeding funnels A and B were added dropwise to the reactor; the addition of the contents of feeding funnels A and B started at the same time (time zero); the addition of the contents of the feeding funnel A was completed after 120 min from time zero, and that of feeding funnel B after 270 min from time zero. Upon the completion of the addition of the contents of feeding funnel A, 15.2 g demineralized water were used to rinse the feeding funnel A. Subsequently, 1.2 g of ammonia solution 25% were added to the reaction mixture. Upon the completion of the addition of the contents of feeding funnel B, 2.8 g demineralized water were used to rinse the feeding funnel B. After the rinsing of the funnel B with demineralized water, stirring continued for another 60 min. The pH was adjusted by adding a solution of 5.6 g of ammonia solution 12.5% to the reactor and mixing continued for additional 15 min. Afterwards, the reactor content was cooled down to 25° C. and a solution of 0.2 g of isoascorbic acid, 3.9 g of demineralized water and 0.1 g of ammonia solution 25% were added and mixing was continued for 30 min. Subsequently, 3.2 g of BIT 10% and 11.2 g of demineralized water were added to the reaction mixture and mixed for 15 min. Subsequently, the thus prepared aqueous coating composition was filtered through a 200 mesh screen.

The aqueous coating composition was an aqueous dispersion characterized as follows:
pH=8.2.
Solids content (%): 45.3
Brookfield viscosity (mPa·s): 225.
Weight amount (g) of vinyl acid-rich copolymer (A1): 117.4.
Weight amount (g) of vinyl acid-poor copolymer (A2): 370.2.
Weight ratio of to A1 to A2:25:75.
M_{w} of component (A): 139400 g/mol.
Amount of component B (g): 39.5.
Amount of component C (g): 0.4.
Average particle size (Z-average; in nm) of the aqueous dispersion: 78.
Particle size distribution of the aqueous dispersion: 0.21.

### Comparative Example 7 (Abbreviated as C7)

547.5 g of demineralized water were added to a 4-neck 2-liter round-bottom glass reactor equipped with a mechanical stirrer, a nitrogen inlet, a water condenser, two feeding funnels A and B, and a heating mantle. 123.9 g of Indurez SR 10 PG, 380.5 g of ENGAGE™ 8407 and 57.2 g of a mixture consisting of 80 wt. % of Kesterwax K62 and 20 wt. % of Radiacid 0075 were added under mechanical stirring followed by the addition of 41.3 g of ammonia solution 25%. Subsequently, the nitrogen-flow is set to 0.2 l/min and the condenser water is turned on. Afterwards, the reactor contents were heated up to 85° C. until Indurez SR 10 PG was completely dissolved. The reaction mixture was maintained at 85° C. for 60 min under continuous stirring. Afterwards, the reaction mixture was cooled down to 25° C. The thus prepared aqueous coating composition phase separated in the reactor.

### Comparative Example 8 (Abbreviated as C8)

A 59.4 g of demineralized water were added to a 250 mL flange reactor equipped with a mechanical stirrer, a nitrogen inlet, a water condenser, and a heating mantle. 179.4 g of Diofan® A050, 9.9 g of Beeswax, 1.7 g of Radiacid 0560 and 0.9 g of ammonia solution 25% were added under mechanical stirring. Subsequently, the nitrogen-flow was set to 0.2 l/min and the condenser water was turned on. Afterwards, the reactor contents were heated up to 85° C. The reaction mixture was maintained at 85° C. for 120 min under continuous stirring. Afterwards, the reaction mixture was cooled down to 25° C.; subsequently, 3.2 g of BIT 10% and 11.2 g of demineralized water were added to the reaction mixture and mixed for 15 min. The reaction mixture gelled in the reactor.

### Comparative Example 9 (Abbreviated as C9)

A 71.7 g of demineralized water were added to a 250 ml flange reactor equipped with a mechanical stirrer, a nitrogen inlet, a water condenser, and a heating mantle. 131.4 g of Diofan® A050, 24.6 g of Indurez SR 10 PG, 9.5 g of Beeswax, 1.7 g of Radiacid 0560 and 11.2 g of ammonia solution 25% were added under mechanical stirring. Subsequently, the nitrogen-flow was set to 0.2 l/min and the condenser water was turned on. Afterwards, the reactor contents were heated up to 85° C. until Indurez SR 10 PG was completely dissolved. The reaction mixture was maintained at 85° C. for 120 min under continuous stirring. Afterwards, the reaction mixture was cooled down to 25° C.; subsequently, 3.2 g of BIT 10% and 11.2 g of demineralized water were added to the reaction mixture and mixed for 15 min. The reaction mixture gelled in the reactor.

### 1.12 Results & Discussion

Table 1 summarizes the comparative and inventive aqueous coating compositions as well as their storage stability and water barrier properties.

From the results shown in Table 1, it is evident that only the inventive aqueous coating compositions provided for a solution to the technical problem. More particularly, when the inventive aqueous coating compositions were according to claim 1, they had excellent storage stability and provided coatings having excellent water barrier properties. It is reminded that:
by ‘excellent storage stability’ of an aqueous coating composition is meant in the specification that the aqueous coating composition shows no sedimentation, no creaming, no phase separation and no gelation during the storage stability test, as the latter is described in the specification;
by ‘poor storage stability’ of an aqueous coating composition is meant in the specification that the aqueous coating composition shows any one or any combination of sedimentation, creaming, phase separation, and gelation during or at the end of the storage period, as the storage stability was assessed in the specification;
by ‘excellent water barrier properties’ is meant in the specification that the coating obtained upon drying an aqueous coating composition (equally referred to as the ‘dry coating’) has:
   a Cobb₁₈₀₀, determined as described in the specification, lower than 6, preferably lower than 5, more preferably lower than 4, even more preferably lower than 3 g/m²,
      and
   a Moisture Vapor Transmission Rate (abbreviated as ‘MVTR’) determined as described in the specification, lower than 50 g·m⁻²·24 h⁻¹.

Each one of the comparative aqueous coating compositions either they were not storage stable and/or they did not provide coatings with excellent water barrier properties; thus, none of the comparative compositions solved the technical problem.

The results shown in Table 1, also demonstrate the criticality and purposiveness of all the features of the inventive compositions and in particular of features a) to c):
a) the chemical make up of the component (A), and
b) the range associated with the weight ratio of the amount of fatty acids containing a carboxylic acid group at one end and a hydrocarbon group with at least 19 and at most 40 carbon atoms at the other end that make up component (C) to the amount of waxes that make up component (B), which range is from 0.10 to 1.20, and that
c) the at least one fatty acid contains a carboxylic acid group at one end and a hydrocarbon group with at least 19 and at most 40 carbon atoms at the other end.

More specifically, upon comparing:
a) any one of the inventive aqueous coating compositions 11 to 17 with comparative aqueous coating compositions C7, C8 and C9, it becomes evident the criticality and purposiveness of the chemical make up of component (A) that is the presence of an acid-rich vinyl copolymer (A1) and an acid-poor vinyl copolymer (A2);
b) the inventive aqueous coating compositions 11 to 17 with comparative aqueous coating compositions C4, and C5, it becomes evident the criticality and purposiveness of the range associated with the weight ratio of the amount of fatty acids containing a carboxylic acid group at one end and a hydrocarbon group with at least 19 and at most 40 carbon atoms at the other end that make up component (C) to the amount of waxes that make up component (B), which range is from 0.10 to 1.20 (C4 had a weight ratio of component (C) to component (B) equal to 0.09 and the corresponding value for the C5 was 1.37), and
c) the inventive aqueous coating composition 11 with comparative aqueous coating composition C3 (which contained a fatty acid but it did not contain a fatty acid reading on component (C) that is it did not contain a fatty acid with a carboxylic acid group at one end and a hydrocarbon group with at least 19 and at most 40 carbon atoms at the other end), it becomes evident the criticality and purposiveness of the finding that the at least one fatty acid should contain a carboxylic acid group at one end and a hydrocarbon group with at least 19 and at most 40 carbon atoms at the other end.

Thus, only the inventive aqueous coating compositions provided a solution to the technical problem and by achieving so the compositions of the invention constitute a major technological advancement in the field of coatings suitable for food-packaging, whereas the comparative aqueous compositions (including those of the state-of the-art) failed to solve the technical problem.

From the results shown above, it is evident that only the aqueous coating compositions according to the claimed invention provided for aqueous coating compositions having excellent storage stability and coatings thereof having excellent water barrier properties. Aqueous coating compositions not according to the claimed invention latter failed to provide for aqueous coating compositions having excellent storage stability and coatings thereof having excellent water barrier properties.

TABLE 1

| | Acid-rich | Acid-poor | | | | Water barrier Properties | |
|---|---|---|---|---|---|---|---|
| | copolymer | copolymer | Component | Weight ratio | Storage | Cobb₁₈₀₀ | MVTR |
| | (A1) | (A2) | (C) | of (C) to (B) | stability | (g/m²) | (g · m⁻² · 24 h⁻¹) |
| I1 | Yes | Yes | Yes | 0.13 | Excellent | 1.5 | 16.4 |
| I2 | Yes | Yes | Yes | 0.28 | Excellent | 1.1 | 18.9 |
| I3 | Yes | Yes | Yes | 0.19 | Excellent | 0.8 | 29.5 |
| I4 | Yes | Yes | Yes | 0.78 | Excellent | 0.6 | 31.0 |
| I5 | Yes | Yes | Yes | 1.05 | Excellent | 0.6 | 24.5 |
| I6 | Yes | Yes | Yes | 0.20 | Excellent | 1.2 | 34.2 |
| I7 | Yes | Yes | Yes | 0.88 | Excellent | 1.6 | 44.2 |
| C1 | Yes | Yes | No⁴ | n.a. | Excellent | 12.2 | 325.0 |
| C2 | Yes | Yes | Yes | 0.05 | Poor | 13.4 | 192.1 |
| | | | | | (creaming) | | |
| C3 | Yes | Yes | No⁵ | 0.00 | Poor (phase | 9.3 | 37.0 |
| | | | | | separation) | | |
| C4 | Yes | Yes | Yes | 0.09 | Poor (phase | 0.8 | 16.9 |
| | | | | | separation) | | |
| C5 | Yes | Yes | Yes | 1.37 | Poor (gelation) | 0.7 | 43.0 |
| C6 | Yes | Yes | Yes | 0.01 | Poor (phase | 0.8 | 23.2 |
| | | | | | separation) | | |
| C7 | Yes | No³ | Yes | 0.13 | n.d.⁶ | n.d. | n.d. |
| C8 | No¹ | No² | Yes | 0.28 | n.d.⁷ | n.d. | n.d. |
| C9 | Yes | No² | Yes | 0.28 | n.d.⁷ | n.d. | n.d. |

¹it contained no acid-rich vinyl copolymer.
²it contained poly(vinylidene chloride).
³it contained ethylene/1-octene copolymer.
⁴it contained neither fatty acid nor wax.
⁵it contained a fatty acid but it did not contain a fatty acid reading on component (C).
⁶the aqueous coating composition phase separated in the reactor, thus no determination of its storage stability.
⁷no aqueous coating composition was obtained; it gelled in the reactor, thus no determination of its storage stability.

1. An aqueous coating composition comprising components (A), (B) and (C):
(A) from 80 to 98 wt. % relative to the total amount of components (A) and (B), of at least two vinyl polymers, comprising
an acid-rich vinyl copolymer (A1) and
an acid-poor vinyl copolymer (A2),
wherein
the acid-rich vinyl copolymer (A1) comprises carboxylic acid functional ethylenically unsaturated monomers in an amount of from 5 to 35 wt. %, and ethylenically unsaturated monomers different from carboxylic acid functional ethylenically unsaturated monomers, selected from the group consisting of acrylic esters, methacrylic esters, arylalkylenes and itaconates, in an amount of from 65 to 95 wt. % relative to the total amount of ethylenically unsaturated monomers used to prepare the acid-rich vinyl copolymer (A1),
and wherein
the acid-poor vinyl copolymer (A2) comprises carboxylic acid functional ethylenically unsaturated monomers in an amount of from 0 to 3 wt. %, and ethylenically unsaturated monomers different from carboxylic acid functional ethylenically unsaturated monomers, selected from the group consisting of acrylic esters, methacrylic esters, arylalkylenes and itaconates, in an amount of from 97 to 100 wt. % relative to the total weight of monomers charged in the polymerization to prepare the acid-poor vinyl copolymer (A2),
and wherein
the weight ratio of (A1) to (A2) is from 10:90 to 40:60,
(B) from 2 to 20 wt. % relative to the total amount of components (A) and (B), of at least one wax,
(C) at least one fatty acid containing a carboxylic acid group at one end and a hydrocarbon group with at least 19 and at most 40 carbon atoms at the other end,
and wherein
the weight ratio of the amount of fatty acids containing a carboxylic acid group at one end and a hydrocarbon group with at least 19 and at most 40 carbon atoms at the other end that make up component (C) to the amount of waxes that make up component (B) is from 0.10 to 1.20,
and wherein
the total amount of components (A), (B) and (C) in the composition is from 30 to 70 wt. % on composition.

2. The aqueous coating composition as claimed in claim 1, wherein the weight ratio of the amount of fatty acids containing a carboxylic acid group at one end and a hydrocarbon group with at least 19 and at most 40 carbon atoms at the other end that make up component (C) to the amount of waxes that make up component (B) is from 0.12 to 1.20.

3. The aqueous coating composition as claimed in any claim 1, wherein the acid-poor vinyl copolymer (A2) comprises carboxylic acid functional ethylenically unsaturated monomers in an amount of from 0 to 1 wt. %, and ethylenically unsaturated monomers different from carboxylic acid functional ethylenically unsaturated monomers, selected from the group consisting of acrylic esters, methacrylic esters, arylalkylenes and itaconates, in an amount of from 99 to 100 wt. % relative to the total weight of monomers charged in the polymerization to prepare the acid-poor vinyl copolymer (A2).

4. The aqueous coating composition as claimed in claim 1, wherein the acid-poor vinyl copolymer (A2) consists of ethylenically unsaturated monomers different from carboxylic acid functional ethylenically unsaturated monomers, selected from the group consisting of acrylic esters, methacrylic esters, arylalkylenes and itaconates.

5. The aqueous coating composition as claimed in claim 1, wherein the acid-rich vinyl copolymer (A1) is at least partially deprotonated with a deprotonation agent A selected from the group consisting of bases and mixtures thereof.

6. The aqueous coating composition as claimed in claim 1, wherein the component (B) is present in an amount of at most 15 wt. % relative to the total amount of components (A) and (B).

7. The aqueous coating composition as claimed in claim 1, wherein the component (B) is present in an amount of at least 2.5 wt. % relative to the total amount of components (A) and (B).

8. The aqueous coating composition as claimed in claim 1, wherein the at least one fatty acid containing a carboxylic acid group at one end and a hydrocarbon group with at least 19 and at most 40 carbon atoms at the other end, is deprotonated with a deprotonation agent B selected from the group consisting of bases and mixtures thereof.

9. The aqueous coating composition as claimed in claim 1, wherein the itaconates of the acid-rich vinyl copolymer (A1) and the itaconates of the acid-poor vinyl copolymer (A2) are selected from the group consisting of esters of itaconic acid, and mixtures thereof.

10. The aqueous coating composition as claimed in claim 1, wherein the at least one wax is selected from the group consisting of vegetable waxes, animal waxes, and mixtures thereof.

11. The aqueous coating composition as claimed in claim 1, wherein the aqueous coating composition is an aqueous dispersion.

12. A coating obtained upon drying an aqueous coating composition as the aqueous coating composition is defined in claim 1.

13. A substrate which is at least partially coated with at least a coating as the coating is defined in claim 12.

14. The aqueous coating composition as claimed in claim 9, wherein the itaconates of the acid-rich vinyl copolymer (A1) and the itaconates of the acid-poor vinyl copolymer (A2) are selected from the group consisting of diesters of itaconic acid, and mixtures thereof.
